(19) United States
(12) Patent Application Publication
(10) Pub. No.: US 2024/0072961 A1
(43) Pub. Date: Feb. 29, 2024

(54) REFERENCE SIGNALS IN DISCONNECTED MODE

(71) Applicant: Sony Group Corporation, Tokyo (JP)

(72) Inventors: Busuki PRIYANTO, Lund (SE); Torgny PALENIUS, Barsebäck (SE); Anders BERGGREN, Lund (SE); Nafiseh MAZLOUM, Lund (SE); Martin BEALE, Bristol (GB); Shin Horng WONG, Basingstoke (GB)

(21) Appl. No.: 18/270,636

(22) PCT Filed: Dec. 17, 2021
(86) PCT No.: PCT/EP2021/086511

§ 371 Date: Jun. 30, 2023

(30) Foreign Application Priority Data
Jan. 15, 2021 (SE) 2150037-6

(51) Int. Cl. H04L 5/00; H04W 72/232

(52) U.S. Cl. CPC H04L 5/0048; H04W 72/232

(57) ABSTRACT

A wireless communication device can monitor for reference signals such as tracking reference signals during disconnected mode. Availability information is obtained when operating in the disconnected mode that is indicative of at least one availability of one or more sporadically-on transmissions of reference signals.

### TECHNICAL FIELD

Various examples generally relate to disconnected-mode operation of a wireless communication device. Various examples specifically relate to a transmission of reference signals while the wireless communication device operates in a disconnected mode.

### BACKGROUND

There is a need to reduce power consumption of wireless communication devices (UEs). One strategy to reduce power consumption of a UE is to operate the UE in a disconnected mode. As a general rule, the disconnected mode provides limited connectivity if compared to a connected mode, but enables a reduced power consumption. This is because a data connection is deactivated, at least along a wireless link between the UE and the communications network.

Then, the disconnected mode may include paging operation and/or a random-access procedure, to re-establish the data connection. For example, in the context of the Third Generation Partnership Project (3GPP), example implementations of the disconnected mode include the Radio Resource Control (RRC) idle mode and RRC inactive mode. See 3GPP Technical Specification (TS), 38.304 Version 16.3 (2020 December).

As a general rule, when operating in a disconnected mode, the UE can typically expect transmissions from the communications network to be restricted to active periods of a discontinuous reception (DRX) cycle; accordingly, during inactive periods of the DRX cycle, the UE can transition some parts of its wireless interface into an inactive state (sometimes also called sleep state). For example, an analog front end and/or more parts of a digital front end and/or other parts can be shut down. This helps to reduce the power consumption.

During disconnected mode, the UE monitors one paging occasion (PO) per DRX cycle. In order to be able to receive data during the active duration of the DRX cycle, typically, the wireless interface is (re-)transitioned into an active state some time before the beginning of the active period. This is because the transitioning from the inactive state to the active state requires some time and, furthermore, it is typically required to re-synchronize with the timing reference of the communications network and/or otherwise adapt the wireless interface to be able to receive data.

To re-synchronize—i.e., to maintain synchronization during a further transmission—, the UE can monitor for reference signals (RSs) transmitted by the communications network when attempting to transition the wireless interface to the active state.

For example, according to existing implementations, the UE can monitor for Synchronization Signal Blocks (SSB) that include RSs.

It has been found that sometimes the process of monitoring for the RSs is comparably inefficient in that it requires significant time and consumes significant power.

### SUMMARY

Accordingly, there is a need for advanced techniques of operating UEs in the disconnected mode using a DRX cycle. In particular, there is a need for advanced techniques of re-acquiring synchronization with a communications network prior to an active period of the DRX cycle.

A method of operating a UE connectable to a communications network may include obtaining configuration information that is indicative of at least one configuration of one or more sporadically-on transmissions of tracking reference signals.

The configuration information may be obtained from a communications network. A respective control message could be indicative of the configuration information.

The configuration information may be obtained while operating in a connected mode or while operating in a disconnected mode.

The method may include obtaining availability information that is indicative of at least one availability of the one or more sporadically-on transmissions of tracking reference signals.

The availability information may be obtained by receiving a message that is indicative of the availability information. One or more signaling modes may be used in order to receive the message. For instance, implicit signaling or explicit signaling could be used.

An activated signaling mode may be determined by the UE. For instance, it would be possible that the activated signaling mode is indicated by the configuration information. The activated signaling mode may change from time to time.

It would also be possible that the at least one availability of the one or more sporadically-on transmissions is inferred, e.g., from one or more states of the communications network and/or operating modes of the UE and/or other signaling.

The UE may monitor for tracking reference signals when operating in a disconnected mode.

A method of operating a UE connectable to a communications network includes receiving, from the communications network and when operating in a disconnected mode, a downlink control information message. The downlink control information message is received on a downlink control channel. The downlink control information message includes availability information. The availability information is indicative of at least one availability of one or more sporadically-on transmissions of tracking reference signals. The method also includes, when operating in the disconnected mode, monitoring for the tracking reference signals that are sporadically transmitted by the communications network in accordance with the at least one availability. The tracking reference signals are suitable for maintaining synchronization with the communications network.

A computer program or a computer-program product or a computer-readable storage medium includes program code. The program code can be loaded and executed by at least one processor. Upon loading and executing the program code, the at least one processor performs a method of operating a UE that is connectable to a communications network. The method includes receiving, from the communications network and when operating in a disconnected mode, a downlink control information message. The downlink control information message is received on a downlink control channel. The downlink control information message includes availability information. The availability information is indicative of at least one availability of one or more sporadically-on transmissions of tracking reference signals. The method also includes, when operating in the disconnected mode, monitoring for the tracking reference signals that are sporadically transmitted by the communications network in accordance with the at least one availability. The tracking reference signals are suitable for maintaining synchronization with the communications network.

A method of operating a UE connectable to a communications network is provided. The method includes, when operating in a disconnected mode, receiving, from the communications network, a downlink control information message on a downlink control channel. The downlink control information message includes scheduling information for a further message. When operating in the disconnected mode, the method also includes receiving, in accordance with the scheduling information from the communications network, the further message on a downlink shared channel. The further message includes availability information indicative of at least one availability of at least one sporadically-on transmission of tracking reference signals. Also, the method includes monitoring for the tracking reference signals that are sporadically transmitted by the communications network in accordance with the at least one availability and when operating in the disconnected mode. The tracking reference signals are suitable for maintaining synchronization with the communications network.

A computer program or a computer-program product or a computer-readable storage medium includes program code. The program code can be loaded and executed by at least one processor. Upon loading and executing the program code, the at least one processor performs a method of operating a wireless communication device that is connectable to a communications network. The method includes, when operating in a disconnected mode, receiving, from the communications network, a downlink control information message on a downlink control channel. The downlink control information message includes scheduling information for a further message. When operating in the disconnected mode, the method also includes receiving, in accordance with the scheduling information from the communications network, the further message on a downlink shared channel. The further message includes availability information indicative of at least one availability of at least one sporadically-on transmission of tracking reference signals. Also, the method includes monitoring for the tracking reference signals that are sporadically transmitted by the communications network in accordance with the at least one availability and when operating in the disconnected mode. The tracking reference signals are suitable for maintaining synchronization with the communications network.

A method of operating an access node of a communications network includes transmitting, to a UE operating in a disconnected mode, a downlink control information message on a control channel. The downlink control information message includes availability information indicative of at least one availability of one or more sporadically-on transmissions of tracking reference signals. Also, the method includes performing the one or more sporadically-on transmissions of the tracking reference signals when the UE operates in the disconnected mode and in accordance with the at least one availability.

A computer program or a computer-program product or a computer-readable storage medium includes program code. The program code can be loaded and executed by at least one processor. Upon loading and executing the program code, the at least one processor performs a method of operating an access node of a communications network. The method includes transmitting, to a UE operating in a disconnected mode, a downlink control information message on a control channel. The downlink control information message includes availability information indicative of at least one availability of one or more sporadically-on transmissions of tracking reference signals. Also, the method includes performing the one or more sporadically-on transmissions of the tracking reference signals when the UE operates in the disconnected mode and in accordance with the at least one availability.

A method of operating an access node of a communications network includes transmitting, to a UE operating in a disconnected mode, a downlink control information message on a downlink control channel. The downlink control information message includes scheduling information for a further message. The method also includes transmitting, in accordance with the scheduling information and to the UE operating in the disconnected mode, the further message on a downlink shared channel. The further message includes availability information that is indicative of at least one availability of one or more sporadically-on transmissions of tracking reference signals. Also, the method includes performing the one or more sporadically-on transmissions of the tracking reference signals when the UE operates in the disconnected mode in accordance with the at least one availability.

A computer program or a computer-program product or a computer-readable storage medium includes program code. The program code can be loaded and executed by at least one processor. Upon loading and executing the program code, the at least one processor performs a method of operating an access node of a communications net-work. The method includes transmitting, to a UE operating in a disconnected mode, a downlink control information message on a downlink control channel. The downlink control information message includes scheduling information for a further message. The method also includes transmitting, in accordance with the scheduling information and to the UE operating in the disconnected mode, the further message on a downlink shared channel. The further message includes availability information that is indicative of at least one availability of one or more sporadically-on transmissions of tracking reference signals. Also, the method includes performing the one or more sporadically-on transmissions of the tracking reference signals when the UE operates in the disconnected mode in accordance with the at least one availability.

A method of operating a UE connectable to a communications network includes obtaining, from the communications network, at least one configuration of one or more sporadically-on transmissions of tracking reference signals. The method also includes, in accordance with one or more predefined rules, inferring at least one availability of the one or more sporadically-on transmissions. When operating in the disconnected mode, the method further includes monitoring for the tracking reference signals sporadically transmitted by the communications network in accordance with the at least one availability. The tracking reference signals are suitable for maintaining synchronization with the communications network.

A computer program or a computer-program product or a computer-readable storage medium includes program code. The program code can be loaded and executed by at least one processor. Upon loading and executing the program code, the at least one processor performs a method of operating a UE that is connectable to a communications network. The method includes obtaining, from the communications network, at least one configuration of one or more sporadically-on transmissions of tracking reference signals. The method also includes, in accordance with one or more predefined rules, inferring at least one availability of the one or more sporadically-on transmissions. When operating in the disconnected mode, the method further includes monitoring for the tracking reference signals sporadically transmitted by the communications network in accordance with the at least one availability. The tracking reference signals are suitable for maintaining synchronization with the communications network.

A method of operating an access node of a communications network includes providing, to a UE operating in a disconnected mode, availability information that is indicative of at least one availability of one or more sporadically-on transmissions of tracking reference signals. The method also includes performing the one or more sporadically-on transmissions of the tracking reference signals when the UE operates in the disconnected mode and in accordance with at least one availability. The method also includes switching between at least two signaling modes used for said providing of the availability information.

A computer program or a computer-program product or a computer-readable storage medium includes program code that can be loaded and executed by at least one processor. Upon loading and executing the program code, the at least one processor performs a method of operating an access node of a communications network. The method includes providing, to a UE operating in a disconnected mode, availability information that is indicative of at least one availability of one or more sporadically-on transmissions of tracking reference signals. The method also includes performing the one or more sporadically-on transmissions of the tracking reference signals when the UE operates in the disconnected mode and in accordance with at least one availability.

The method also includes switching between at least two signaling modes used for said providing of the availability information.

A method of operating a UE that is connectable to a communications network includes determining an activated signaling mode used to provide availability information indicative of at least one availability of one or more sporadically-on transmissions of tracking reference signals. The method also includes, when operating in a disconnected mode, obtaining, from the communications network, the availability information in accordance with the activated signaling mode. The method further includes, when operating in the disconnected mode, monitoring for the tracking reference signal sporadically transmitted by the communications network in accordance with the at least one availability.

The tracking reference signals are suitable for maintaining synchronization with the communications network.

A computer program or a computer-program product or a computer-readable storage medium includes program code. The program code can be loaded and executed by at least one processor. Upon loading and executing the program code, the at least one processor performs a method of operating a UE that is connectable to a communications network. The method includes determining an activated signaling mode used to provide availability information indicative of at least one availability of one or more spo-radically-on transmissions of tracking reference signals. The method also includes, when operating in a disconnected mode, obtaining, from the communications network, the availability information in accordance with the activated signaling mode. The method further includes, when operating in the disconnected mode, monitoring for the tracking reference signal sporadically transmitted by the communications network in accordance with the at least one availability. The tracking reference signals are suitable for maintaining synchronization with the communications network.

A wireless communication device and/or an access node are configured according to the methods as described above.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates tracking reference signals according to various examples.

FIG. 2 schematically illustrates a cellular network according to various examples.

FIG. 3 schematically illustrates multiple operational modes including a connected mode and multiple disconnected modes in which a UE according to various examples can operate.

FIG. 4 schematically illustrates details with respect to UE operation in a disconnected mode according to various examples.

FIG. 5 schematically illustrates a base station according to various examples.

FIG. 6 schematically illustrates a UE according to various examples.

FIG. 7 is a flowchart of a method according to various examples.

FIG. 8 schematically illustrates downlink control information messages, paging messages, and system information block messages according to various examples.

FIG. 9 is a flowchart of a method according to various examples.

FIG. 10 is a flowchart of a method according to various examples.

FIG. 11 is a signaling diagram of signaling between the base station and the UE according to various examples.

FIG. 12 is a signaling diagram of a variant of communicating availability information of a sporadically-on transmission according to various examples.

FIG. 13 is a signaling diagram of a further variant of communicating availability information of a sporadically-on transmission according to various examples.

FIG. 14 is a signaling diagram of yet a further variant of communicating availability information of a sporadically-on transmission according to various examples.

FIG. 15 schematically illustrates base-station operation when changing from an on-availability of a sporadically-on transmission of tracking reference signals to an off-availability of the sporadically-on transmission according to various examples.

FIG. 16 schematically illustrates a base station operation including negative trigger events for temporarily suspending performing a sporadically-on transmission of tracking reference signals according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is de-sired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combi-nation thereof.

Various aspects relate to a communication system. For example, the communication system may be implemented by a UE and an access node of a communications net-work (NW). For example, the access node may be implemented by a base station (BS) of a cellular communications NW (simply, cellular NW hereinafter). Hereinafter, for sake of simplicity various examples will be described in connection with an implementation of the communication system by a UE connectable to a cellular NW. However, similar techniques may be readily employed for other kinds and types of communication systems.

The communication system may include a wireless link between the UE and the BS. Downlink (DL) signals may be transmitted by the BS and received by the UE. Uplink (UL) signals may be transmitted by the UE and received by the BS.

Hereinafter, techniques will be described that facilitate operation of a UE in a disconnected mode. The disconnected mode may restrict connectivity, e.g., in terms of when the UE can receive data and/or in terms of what signals the UE can receive. The disconnected mode can generally enable a UE to shut down partly or fully one or more components of its wireless interface. When a UE operates in the disconnected mode, it is possible that the cellular NW discards certain information associated with the UE, e.g., certain information of the UE context, etc. It would be possible that a UE-specific data connection on the wireless link between the cellular NW and the UE is released; on the other hand, a section of the data connection may be maintained in a core of the communications NW.

As a general rule, the UE operating in the disconnected mode can use a DRX cycle, i.e., iteratively switch the wireless interface between an active state and an inactive state (sometimes referred to as sleep state). When in the inactive state, the wireless interface may be unfit to receive data. When switching from the inactive state to the active state, the UE may monitor for a RS. The UE may also monitor for a further transmission, e.g., a paging signal.

Examples of disconnected modes are 3GPP Idle and 3GPP Inactive modes.

As a general rule, the disconnected mode can be associated with paging operation. Here, one or more paging signals are transmitted by the communications NW to the UE at a paging occasion (PO). The PO is time-aligned with the active duration of the DRX cycle.

There are various tasks that the UE may perform when operating in the disconnected mode that may require that the UE maintains synchronization with the cellular NW.

Some examples are summarized in TAB. 1 below.

TABLE 1
Various examples of communication from the UE to the cellular NW
or from the cellular NW to the UE when the UE operates in the disconnected
mode that require synchronization of the UE with a timing reference
of the cellular NW. According to the various examples, RSs are transmitted
that are suitable for maintaining synchronization in such a communication
between the UE and the cellular NW.

| | |
|---|---|
| I | For example, the UE may require maintaining synchronization to receive one |
| | or more paging signals, e.g., a paging indicator and a paging message. The |
| | one or more paging signals can be indicative of the cellular NW paging the UE, |
| | e.g., because DL payload data is buffered for transmission and thus a transition |
| | of the UE to the connected mode is triggered. |
| II | In a further example, the UE may require maintaining synchronization to |
| | receive a system information Block (SIB). The SIB can be indicative of one or |
| | more transmission parameters used by the base station of the cellular NW |
| | transmitting the SIB. Such one or more transmission parameters may be |
| | required by the UE to communicate with the cellular NW. |
| III | In yet a further example, the UE may require maintaining synchronization to |
| | perform a cell measurement such as a serving cell measurement of DL RSs |
| | transmitted by the BS to which the UE has been previously connected or DL |
| | RSs transmitted by one or more neighboring BSs, then referred to as neighbor |
| | cell measurements. |
| IV | In yet a further example, the UE may require maintaining synchronization to |
| | transmit a random-access (RA) preamble of an RA procedure when transitioning |
| | from the disconnected mode to a connected mode and/or when performing |
| | an early data transfer in a RA procedure. |
| V | In yet a further example, the UE may require maintaining synchronization for |
| | performing a re-selection of a cell. For instance, due to UE mobility, the UE |
| | may move from the coverage area of a first BS into the coverage of the second |
| | BS, when operating in the disconnected mode. Then, it is possible that the UE |
| | reselects the cell. |

An RS generally denotes a signal that has a well-defined transmit property—e-g. amplitude, phase, symbol sequence, and/or precoding, etc.—that is also known to the receiver. Based on a receive (RX) property of the RS—e.g., based on the received amplitude or the received phase of the RS—it is then possible to tune one or more properties of the wireless interface. For instance, a radio-frequency oscillator may be tuned; phase shifts may be compensated. The RS is suitable/configured to be used by the UE to maintain synchronization with the communications NW. It would be possible to sound one or more channels (e.g., pertaining to different spatial streams) on the wireless link, by monitoring receive properties of RSs transmitted and concluding on, e.g., a channel matrix, path loss, fading and/or other properties of the channel based thereon.

Then, the UE can attempt to demodulate a further transmission from the communications NW based on the RX property of the RS. For example, the UE may attempt to demodulate a further transmission during or prior to the active period of the DRX cycle. Alternatively or additionally, the UE can modulate a further transmission to the communications NW based on the RX property of the RS. Thus, as a general rule, the RS can be suitable for maintaining synchronization in a further communication between the UE and the NW. Examples are explained in connection with TAB. 1.

Hereinafter, techniques are described that facilitate efficient—e.g., low-latency and/or energy-efficient and/or low-overhead—synchronization with the cellular NW. The efficient synchronization can be obtained through appropriate strategies for the transmission of the DL RS.

For example, a sporadically-on transmission of the RS may be used. I.e., a transmission of the RS may be relied upon which is not always-on. This means that the UE will not make an assumption on the presence of the RS on the wireless link unless the sporadically-on transmission is configured for the UE and the UE receives respective signaling from the cellular NW (in contrast to an always-on transmission). More specifically, the UE may require (i) a configuration of the sporadically-on transmission, as well as (ii) an indication of the sporadically-on transmission being activated (on-availability). A sporadically-on transmission of the RSs can be configured by the cellular NW on-demand. The sporadically-on transmission of the RS can be activated and then de-activated again, by the cellular NW; i.e., the availability of the sporadically-on transmission may be changed or toggled between an off-availability and an on-availability; this means that for a given configuration the sporadically-on transmission of RSs can be switched on and off, without the configuration changing.

For example, as a general rule, a configuration information of a sporadically-on transmission of RSs may be indicative of time-frequency resources of the time-frequency resource grid on which the RSs are located. The configuration information could be indicative of a timing of the RSs, e.g., a periodicity and/or a time offset with respect to certain reference timings, e.g., a PO or SSB transmission. The configuration information could be indicative of a sequence format of the RSs. The configuration information could be indicative of one or more transmit beams used by the base station to transmit the RSs of the sporadically-on RS transmission.

The sporadically-on transmission of the RS may use time-frequency resources in a time-frequency resource grid that are specifically allocated when configuring the spo-radically-on transmission. A respective configuration can be indicative of such time-frequency resources. This may be different to an always-on transmission where respective re-occurring resources may be statically allocated, e.g., at certain reserved sections of a subframe of the transmission protocol used for communicating on the wireless link.

As a general rule, it would be possible that the RS of the sporadically-on transmission is indicative of a cell identity of the cell of the cellular NW. The RS of the sporadically-on transmission can be sequence-based. For instance, a symbol sequence of, e.g., a Zadoff-Chu sequence or a maximum-length sequence may be used. Scrambling and/or interleaving may be used. The sporadically-on transmission may map the RS to multiple subcarriers within an Orthogonal Frequency Division Multiplexing (OFDM) symbol.

An example implementation of the sporadically-on transmission of the RS may rely on Channel State Information RSs (CSI-RSs) or specifically tracking RSs (TRSs). In contrast, an always-on transmission of a RS may rely on, e.g., one or more of a primary synchronization signal (PSS), a secondary synchronization signal (SSS), or a cell-specific RS. The PSS and/or the SSS signal can be included in a repeatedly broadcasted synchronization signal block (SSB) that also includes other components such as a physical broadcast channel, carrying an information block including cell-specific information, and demodulation reference signals (DMRS), intended to assist UE for the demodulation of physical broadcast channel.

According to various examples, TRSs are transmitted to UEs operating in an idle mode. Due to oscillator imperfections, the UE tracks and compensates for variations in time and frequency to successfully communicate data between the cellular NW and the UE.

For this, TRSs can be used. A TRS generally describes a resource set consisting of multiple periodic non-zero-power CSI-RSs. More specifically, a TRS may consist of four one-port, density-3 CSI-RSs located within two consecutive slots of a communication protocol used by the UE and the cellular NW. TRS are generally described in 3GPP Technical Specification 38.214, Version 16.4, (2020-12).

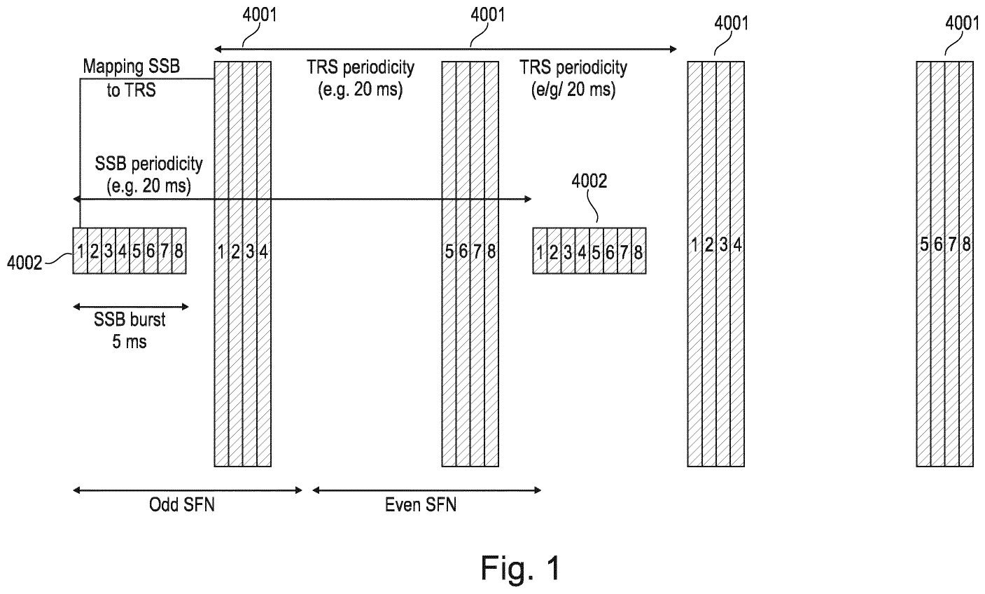

In legacy systems (e.g., 3GPP New Radio, NR, rel.15 and 16), the TRS is utilized only by the UE operating in connected mode. The configuration of the TRS transmission is specifically provided by the BS to each UE. TRS can be configured with certain periodicity and typically configured with an association with the transmission of SSBs, e.g. quasi-colocated (QCL'ed). An example of TRS resource allocation and its relationship with SSB is shown in FIG. 1. Here, multiple bursts of TRSs 4001 are transmitted QCL'ed with SSBs 4002.

As illustrated in FIG. 1, the sporadically-on transmission of the RS may define a repet-itive transmission scheme. This may be associated with respect to a corresponding repetition rate of the RS. A timing schedule of the RS may be specified in the TRS configuration. A sequence format of the TRS may be specified in the TRS configuration.

Because the always-on transmission of a respective further RS is always available, the sporadically-on transmission of the RS is contemporaneous (i.e., available at the same time) with the always-on transmission. Thus, in principle, the UE may select to attempt to receive (monitor) the further RS of the always-on transmission or the RS of the spo-radically-on transmission, or both.

As a general rule, according to the various examples disclosed herein it would be possible that a repetition rate of the sporadically-on transmission of the RS (e.g., TRS) can be higher than a repetition rate of the always-on transmission of a further RS (e.g., PSS). This may have the benefit that a latency until reception of the RS of the sporad-ically-on transmission is comparably short. Thus, a time-to-synchronization can be reduced when the UE monitors for the RS of the sporadically-on transmission when operating in the disconnected mode.

As a further general rule, according to the various examples disclosed herein it would be possible that a bandwidth of the sporadically-on transmission of the RS is larger than a bandwidth of the always-on transmission of the further RS. This means that the sporadically-on transmission may cover a broader frequency range compared to the always-on transmission. Wider bandwidth RS transmission would enable fine fre-quency/time synchronization. For instance, multiple RSs may be scattered across the broader bandwidth, or a single RS may occupy a comparably large bandwidth.

Various techniques are based on the finding that because a sporadically-on transmission of the RS may be used by the UE operating in the disconnected mode using the DRX cycle, the UE—once transitioning the wireless interface back from the inactive state to the active state in preparation for monitoring a PO—may require some addi-tional information regarding whether the sporadically-on transmission of the RS is currently available by the communications NW or not (in particular in contrast to an al-ways-on transmission of the RS for which the UE may simply begin monitoring, because it is always active and the UE makes the respective assumption without dedicated DL signaling from the cellular NW). The UE may generally require availability information indicative of the availability of the sporadically-on transmission. Lack of the availability information can result in the UE using the legacy SSB for synchronization which may increase power consumption; further, lack of the availability information can result in the UE performing blind detection to detect whether TRSs are transmitted or not which may also increase power consumption.

Obtaining the availability information from the cellular NW can be difficult for the UE in disconnected mode, because there is a limited possible communication exchange between UE and the BS. According to various examples described herein, techniques are provided that facilitate a corresponding exchange of the availability information indicative of at least one availability of one or more sporadically-on transmissions of TRS between the cellular NW and the UE.

According to various examples, there are multiple options available for obtaining the availability information, see TAB. 2 below.

TABLE 2
Two options for indicating availability information of at least one
sporadically-on transmission of RSs. According to various examples,
it is possible to combine such two options, e.g., the UE may initially
operate based on the scenario II, implicit indication, and then switch
to scenario I. For example, it would be possible that different signaling
modes are defined with respect to such options and that it is possible
to switch between the different signaling modes, e.g., using a respective
indication in configuration information.

| | Example | |
|---|---|---|
| | indication | |
| | mode | Example details |
| I | Explicit | The availability information may be explicitly signaled |
| | indication | while the UE operates in the disconnected mode. The UE |
| | | read the availability information. |
| | | Explicit indication means that there is a dedicated |
| | | signal conveying availability information. The |
| | | availability information can signal the availability |
| | | of each sporadically-on transmission of TRSs using, |
| | | e.g., a single bit: |
| | | TRS_availability = 0; // TRS is not transmitted/ |
| | | unavailable |
| | | TRS_availability = 1; //TRS is transmitted/available |
| II | Implicit | The availability information may not be explicitly |
| | indication | signaled; rather the UE may infer the availability |
| | | information from other states of the UE and/or the |
| | | cellular NW or further signals. This means that the |
| | | UE may require a prior knowledge - e.g., one or more |
| | | predefined rules - to infer the availability to thereby |
| | | conclude on the least one availability indicated by the |
| | | availability information. |

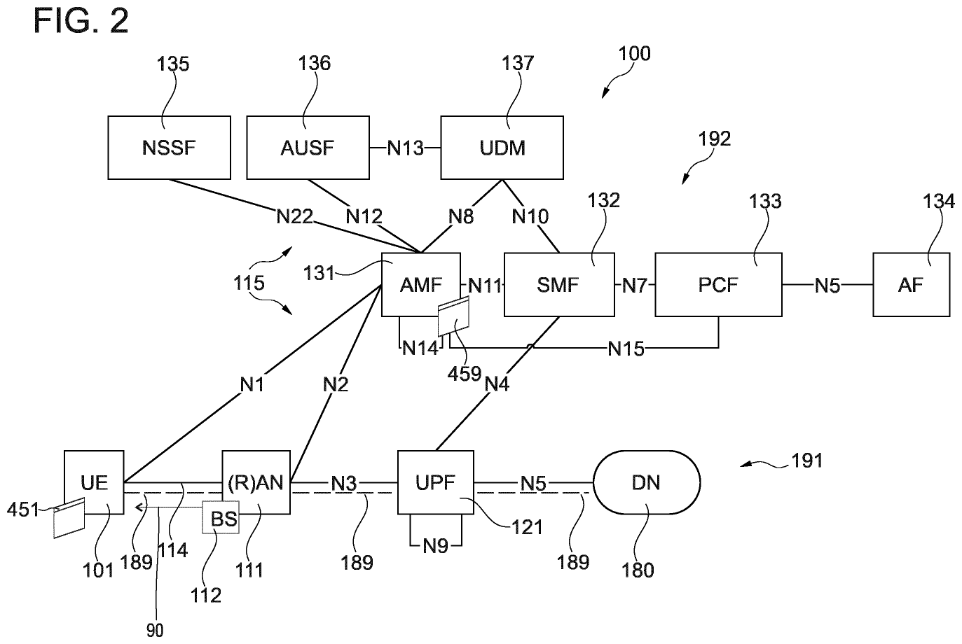

FIG. 2 schematically illustrates a cellular NW 100. The example of FIG. 2 illustrates the cellular NW 100 according to the 3GPP 5G architecture. Details of the 3GPP 5G architecture are described in 3GPP TS 23.501, version 15.3.0 (2017 September). While FIG. 2 and further parts of the following description illustrate techniques in the 3GPP 5G framework of a cellular NW, similar techniques may be readily applied to other communication protocols. Examples include 3GPP LTE 4G—e.g., in the MTC or NB-IoT framework—and even non-cellular wireless systems, e.g., an IEEE Wi-Fi technology.

In the scenario of FIG. 2, a UE 101 is connectable to the cellular NW 100. For example, the UE 101 may be one of the following: a cellular phone; a smart phone; an IoT device; a MTC device; a sensor; an actuator; etc. The UE 101 has a respective identity 451, e.g., a subscriber identity.

The UE 101 is connectable to a core NW (CN) 115 of the cellular NW 100 via a RAN 111, typically formed by one or more BSs 112 (only a single BS 112 is illustrated in FIG. 2 for sake of simplicity). A wireless link 114 is established between the RAN 111—specifically between one or more of the BSs 112 of the RAN 111—and the UE 101. To perform channel sounding and/or enable the UE 101 to maintain synchronization, it is possible that the BS 112 provides one or more transmissions of one or more RSs.

For example, the BS 112 can provide an always-on transmission of first RSs. The BS 112 can also provide one or more sporadically-on transmissions of second RSs. For this, the BS 112 can configure the respective sporadically-on transmission(s) for one or more UEs that are connected or have been connected to the respective cell of the cellular NW 100, e.g., by maintaining a respective registry.

The wireless link 114 implements a time-frequency resource grid. Typically, OFDM is used: here, a carrier includes multiple subcarriers. The subcarriers (in frequency domain) and the symbols (in time domain) then define time-frequency resource elements of the time-frequency resource grid. Thereby, a protocol time base is defined, e.g., by the duration of frames and subframes including multiple symbols and the start and stop positions of the frames and subframes. Different time-frequency resource elements can be allocated to different logical channels of the wireless link 114. Examples include: Physical DL Shared Channel (PDSCH); Physical DL Control Channel (PDCCH); Physical Uplink Shared Channel (PUSCH); Physical Uplink Control Channel (PUCCH); channels for random access; etc.

The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 2, the UPF 121 acts as a gateway towards a data NW 180, e.g., the Internet or a Local Area NW. Application data can be communicated between the UE 101 and one or more servers on the data NW 180.

The cellular NW 100 also includes a mobility-control node, here implemented by an Access and Mobility Management Function (AMF) 131 and a Session Management Function (SMF) 132.

The cellular NW 100 further includes a Policy Control Function (PCF) 133; an Application Function (AF) 134; a NW Slice Selection Function (NSSF) 134; an Authentication Server Function (AUSF) 136; and a Unified Data Management (UDM) 137. FIG. 2 also illustrates the protocol reference points N1-N22 between these nodes.

The AMF 131 provides one or more of the following functionalities: connection management sometimes also referred to as registration management; NAS termination for communication between the CN 115 and the UE 101; connection management; reach-ability management; mobility management; connection authentication; and connection authorization. For example, the AMF 131 controls CN-initiated paging of the UE 101, if the respective UE 101 operates in the idle mode. The AMF 131 may trigger transmission of paging signals to the UE 101; this may be time-aligned with POs. The timing of the POs can be determined based on the UE identity 451. I.e., POs are associated with the respective UEs based on their identify. After UE registration to the NW, the AMF 131 creates a UE context 459 and keeps this UE context, at least as long as the UE 101 is registered to the NW. The UE context 459 can hold one or more identities of the UE 101, e.g., temporary identities used for paging as described herein.

A data connection 189 is established by the SMF 132 if the respective UE 101 operates in a connected mode. The data connection 189 is characterized by UE subscription information hosted by the UDM 137. To keep track of the current mode of the UE 101, the AMF 131 sets the UE 101 to CM-CONNECTED or CM-IDLE. During CM-CONNECTED, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 and the RAN 111 and on to the UP 191 of the CN 115 and towards the DN 180. For example, a connection with the Internet or another packet data NW can be established. To establish the data connection 189, i.e., to connect to the cellular NW 100, it is possible that the respective UE 101 performs an RA procedure, e.g., in response to reception of paging signals.

This establishes at least a RAN-part of the data connection 189. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the OSI model.

FIG. 2 illustrates that a sporadically-on transmission 90 of TRSs 4001 can be provided by the BS 112.

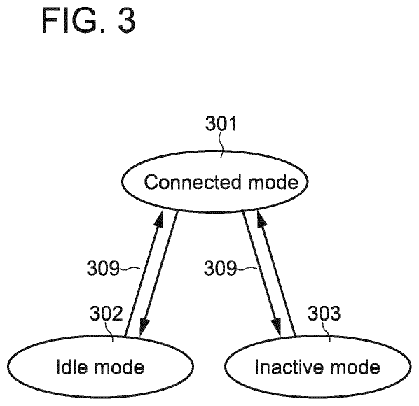

FIG. 3 schematically illustrates aspects with respect to multiple operational modes 301-303 in which a UE can operate.

The data connection 189 is established in the connected mode 301. In particular, a RAN-part of the data connection 189 is established in the connected mode 301. Data can be communicated between the UE 101 and the BS 112 using PDSCH, PDCCH, PUSCH, PUCCH. RRC control messages can be communicated on PDSCH and/or PUSCH. It is possible to use connected-mode DRX. The connected mode 301 can be implemented by the 3GPP RRC connected mode.

FIG. 3 also illustrates two disconnected modes 302-303. A first disconnected mode is the idle mode 302, e.g., implemented by 3GPP RRC idle mode. A second disconnected mode is the inactive mode 303, e.g., implemented by 3GPP RRC inactive mode. Typically, the inactive mode 303 is transparent to the CN 115; while the idle mode 302 may be signaled to the CN 115.

FIG. 3 also illustrates aspects with respect to the transitions 309 between the various modes 301-303. For instance, to trigger the transition 309 from the connected mode 301 to one of the disconnected modes 302-303, a connection deactivation message can be communicated, e.g., using an RRC control message on the PDSCH. This may be a connection inactivate control message for the transition 309 to the inactive mode 303; or a connection release message for the transition 309 to the idle mode 302. The connection release message triggers release of the data connection 189.

The transition 309 from the idle mode 302 or the inactive mode 303 to the connected mode 301 includes an RA procedure. The RA procedure may be triggered by paging signals, e.g., a paging indicator on PDCCH and a paging message on PDSCH. In the inactive mode 303, paging can be triggered by the RAN; while in the idle mode 302 the paging is triggered by the CN.

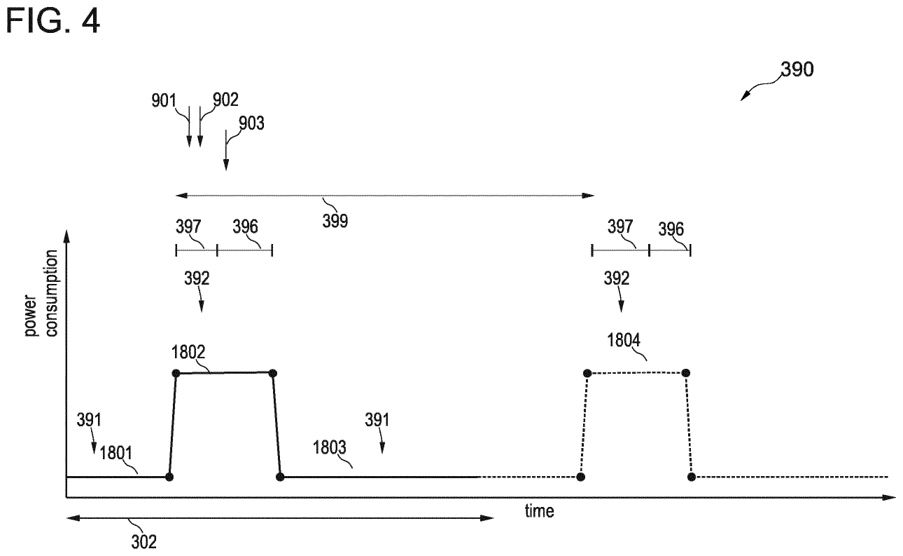

The paging signals are transmitted at POs. The timing of the POs is determined depending on the identity 451 of the UE 101. The UE 101 can configure a DRX cycle in accordance with the timing of the POs. In particular, the UE 101 can control its wireless interface such that it is in the active state and ready to receive data—e.g., by blind decoding PDCCH and searching for paging information in which the CRC is masked with a paging indication identifier (Paging-RNTI; herein also referred to as paging indicator, because it points to the paging message)—at the start of the active period of the DRX cycle. Details with respect to the operation of the UE 101 using the DRX cycle are illustrated in FIG. 4.

FIG. 4 schematically illustrates aspects with respect to a DRX cycle 390. The DRX cycle 390 can be used by the UE 101 in one or both of the disconnected modes 302-303. FIG. 4 illustrates activity of the various components of the wireless interface of the UE 101 as a function of time, to implement a DRX cycle 390. More specifically, FIG. 4 illustrates the activity of the various components of the wireless interface by indicating the UE power consumption.

When using the DRX cycle 390, the UE 101 periodically transitions a modem of its wireless interface between an inactive state 391 (during time periods 1801 and 1803 in FIG. 4) and an active state 392 (during time periods 1802 and 1804 in FIG. 4). The time periods 1801 and 1803 correspond to inactive periods of the DRX cycle 390; and the time periods 1802 and 1804 corresponds to active periods of the DRX cycle 390. The time period 1802 of the active state 392 is time-aligned with a PO 396 during which the cellular NW 100 can send the paging indicator on the PDCCH and paging mes-sage(s) on the PDSCH. FIG. 4 illustrates a corresponding cycle duration 399 of the DRX cycle 390, i.e., the periodicity or duration of individual periods of the DRX cycle 390.

The timing of the PO 396 is given (for the example of 3GPP NR) by (i) the Subframe Frame Number (SFN) and (ii) the subframe within this frame and (iii) the UE_ID, which is derived from the respective identity 451 of the UE 101.

The UE 101 cannot receive paging signals when operating the modem in the inactive state 391; for example, an analog front end and/or a digital front end of the modem may be powered down. For example, amplifiers and analog-to-digital converters may be switched off. For example, decoding digital blocks may be switched off. The UE hardware is entering the inactive state 391 when it is possible to save power. When the UE hardware is in the inactive state 391, one or more clocks may be turned off, all radio blocks and most modem blocks may be turned off, just minimum activity with a low frequency (RTC) clock to start the platform when it is time for the next PO 396 may be maintained. Accordingly, the inactive state 391 is associated with a comparably small power consumption.

When operating the modem in the active state 392 during the active periods of the DRX cycle 390, the UE 101 activates its RF components to be able to receive signals. When operating in the active state 392, the UE 101 can monitor for signals transmitted by the BS 112. Specifically, the UE 101 can prepare for the PO 396 by monitoring for RSs, to thereby maintain synchronization with the cellular NW 100. Thus, each active period can include a preparation duration 397 prior to a respective PO 396. When operating in the active state 392, the various hardware components of the modem of the wireless interface are powered up and operating.

For example, the UE 101 can perform blind decoding of the PDCCH to detect a paging indicator or a SIB-update indicator. This is explained in greater detail hereinafter.

Generally speaking, the PDCCH assists transmission of payload data on the PDSCH. The PDCCH includes control messages that enable to receive, demodulate, and decode the payload data communicated on the PDSCH. DL Control Information (DCI) messages are transmitted through the PDCCH and include scheduling information about the resource allocation (the set of resource blocks of the time-frequency resource grid containing the PDSCH), transport format and information related to the Hybrid Automatic Repeat Request (ARQ) protocol.

The DCI undergoes channel coding: a cyclic redundancy checksum (CRC) is added, coding—e.g., convolutional or polar coding—and rate matching is performed, according to PDCCH format capacity. The coded DCI bits form the DCI message communicated on the PDCCH. These coded bits are then converted to complex modulated symbols after performing operations including scrambling, QPSK modulation, layer mapping and precoding. Finally, the modulated symbols are interleaved and mapped to physical Resource Elements (REs) of the time-frequency resource grid.

After performing deinterleaving, de-precoding, symbol combining, symbol demodulation and descrambling, the UE performs blind decoding of the PDCCH payload: The UE is unaware of the structure of the PDCCH, including the number of PDCCHs and the number of control-channel elements (CCEs) to which each DCI message is mapped. Multiple PDCCHs can be transmitted in a single subframe which may or may not be all relevant to a particular UE. The UE finds the relevant PDCCH(s) by monitoring a set of CCEs periodically. The UE uses a Radio Network Temporary Identifier (RNTI) to try to decode candidates (blind decoding). More specifically, the RNTI is used to demask candidate CRCs. If no CRC error is detected the UE determines that PDCCH carries its own control information; otherwise, respective bits can be dis-carded.

The PDCCH carries scheduling information and other control information in the form of DCI messages. There are multiple formats of the DCI defined, depending on the information content. The PDCCH is masked with temporary identifiers to identify the information content. If the PDCCH contains paging information (paging indicator), the CRC will be masked with a paging indication identifier i.e. Paging-RNTI (P-RNTI). This is also referred to as paging DCI message. The DCI then includes scheduling information for the paging message transmitted on the PDSCH. If the PDSCH contains SIB, i.e., a system information-RNTI (SI-RNTI) will be used to mask the CRC. This is referred to as SIB indicator, e.g., used to signal a change of the SIB to that the UE will read the SIB and update its configuration accordingly.

With the possibilities of different RNTIs, PDCCH candidates, DCI and PDCCH formats, a significant number of attempts may be required to successfully decode the PDCCH.

This is the reason why blind decoding can require significant energy. The active state 392 is accordingly associated with a comparably high power consumption, as illustrated in FIG. 4.

As illustrated in FIG. 4, the UE 101 can receive one or more RSs 901, 902 during the time period 1802, to (re-)synchronize. Specifically, this is in the preparation duration 397 ahead of the respective PO 396. The UE 101 can re-synchronize prior to blind decoding the PDCCH, as explained above. A respective PDSCH payload 903 is also illustrated in FIG. 4.

In the scenario of FIG. 4, the UE 101 does not receive a paging indicator on the PDCCH during the time period 1802 or, more specifically, during the PO 396. Accordingly, transitions back into the inactive state 391 during the time period 1803. The procedure is repeated after the periodicity 399 of the DRX cycle 390 (as illustrated by the dashed line of FIG. 4). Once a paging indicator is detected, the UE 101 next reads a paging message mapped to the Paging Channel (PCH) transport channel that is mapped to the PDSCH. Based on the paging message, the data connection 189 can be set up.

Hereinafter, strategies are described that facilitate shortening the time period 1802 by fast synchronization. In particular, strategies are described that facilitate such shortening of the time period 1802 by providing a transmission of a RS 901 that facilitates fast and/or fine synchronization during the time period 1802. Specifically, the RSs 901 and/or the RSs 902 could be TRSs of a respective sporadically-on transmission 90.

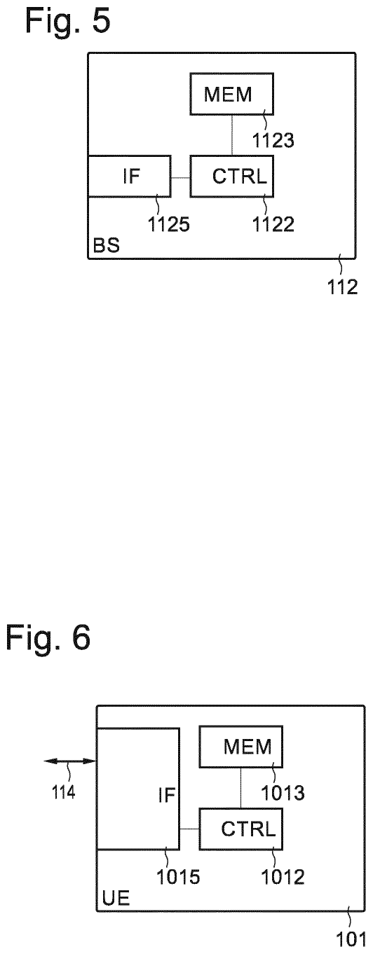

FIG. 5 schematically illustrates the BS 112. The BS 112 includes control circuitry 1122 that can load program code from a memory 1123. The BS 112 also includes an interface 1125 that can be used to communicate on the wireless link 114 with the UE 101 or nodes of the CN 115 of the cellular NW 100. As such, the interface 1125 can include an analog front end and a digital front end, as well as antenna ports, etc., for communicating on the wireless link 114. The control circuitry 1122 can load program code from the memory 1123 and execute the program code. Upon executing the program code, the control circuitry 1122 can perform techniques as described herein, e.g.: configuring and providing at least one transmission of RSs, e.g., a sporadically-on transmission and/or an always-on transmission; providing a configuration of at least one transmission of RSs to the UE 101; changing the availability of a sporadically-on transmission of reference signals, e.g., toggling between an on-availability in which the reference signals are transmitted and then an off-availability in which the reference signals are not transmitted; providing, to the UE 101, availability information indicative of the availability of the sporadically-on transmission, e.g., in accordance with such toggling between the on-availability and the off-availability, etc.

FIG. 6 schematically illustrates the UE 101. The UE 101 includes control circuitry 1012 that can load program code from the memory 1013. The UE 101 also includes a wireless interface 1015 that can be used to communicate on the wireless link 114 with the BS 112 of the cellular NW 100. As such, the wireless interface 1015 can include an analog front end and a digital front end, as well as antenna ports, etc. The control circuitry 1012 can load program code from the memory 1013 and execute the program code. Upon executing the program code, the control circuitry 1012 can perform techniques as described herein, e.g.: monitoring for RSs, e.g., when operating in a disconnected mode 302-303; transmitting an indication of a capability to the cellular NW 100 to monitor for a RS of a sporadically-on transmission when operating in a disconnected mode 302-303; obtaining a configuration of at least one transmission of RSs from the cellular NW 100 and monitoring for the RSs in accordance with the configuration; obtaining availability information that is indicative of the availability of a sporadically-on transmission of reference signals; monitoring for the reference signals of the sporadically-on transmission in accordance with the availability of the sporadically-on transmission; selecting between monitoring for reference signals of a sporadically-on transmission and reference signals of an always-on transmission, e.g., in accordance with the availability of the sporadically-on transmission; controlling the wireless interface 1015 to switch between the inactive state 391 and the active state 392; operating in one of the modes 301-303; etc.

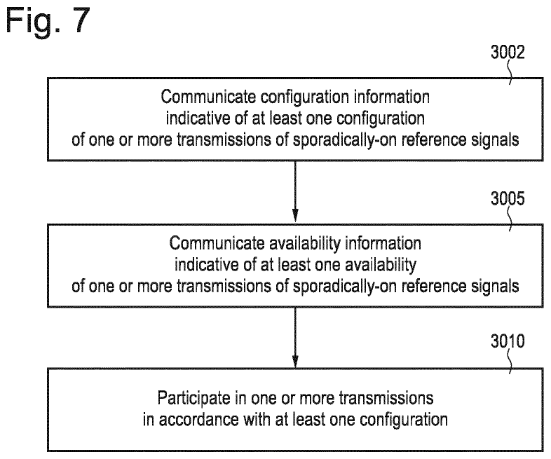

FIG. 7 is a flowchart of a method according to various examples. For instance, the method of FIG. 7 could be executed by a BS. For example, the method of FIG. 7 could be executed by the BS 112, e.g., by the control circuitry 1122 upon loading program code from the memory 1123. Alternatively or additionally, the method could also be executed by a UE. For example, the method of FIG. 7 could be executed by the UE 101. The method of FIG. 7 could be executed by the control circuitry 1012 upon loading program code from the memory 1013.

At box 3002, configuration information is communicated between the BS and the UE. This can include the BS transmitting the configuration information and/or the UE receiving the configuration information. The configuration information is indicative of at least one configuration of one or more sporadically-on transmissions of TRSs, cf. FIG. 1: TRS 4010, and cf. FIG. 2, sporadically-on transmission 90.

For example, the configuration information of a sporadically-on transmission of TRSs may be indicative of time-frequency resources of the time-frequency resource grid on which the TRSs are located. The configuration information could be indicative of a timing of the TRSs, e.g., a periodicity and/or a time offset with respect to certain reference timings, e.g., a PO or SSB transmission, cf. FIG. 1. The configuration information could be indicative of a sequence format of the TRSs. The configuration information could be indicative of one or more transmit beams used by the base station to transmit the TRSs of the sporadically-on TRS transmission.

According to the various examples, it would be possible that the configuration information is indicative of a signaling mode of availability information, cf. box 3005. For example, one instance of configuration information could state that availability information is signaled using paging DCI; another instance of configuration information could state that availability information is signaled using SIB DCI; another instance of the configuration information could state that the availability information is implicitly signaled. Respective options for signaling modes are discussed in connection with TAB. 2, TAB. 3, and TAB. 7.

According to the various examples, it would be possible that the configuration information is indicative of a codebook that is used to signal the availability information. For instance, the availability information may include an index encoded in one or more bits that is to be interpreted in accordance with the codebook by the UE. Different code-books can result in different interpretations, e.g., define whether a given sporadically-on transmission of TRSs has an on-availability or off-availability, or whether different sporadically-on transmissions of TRSs are available.

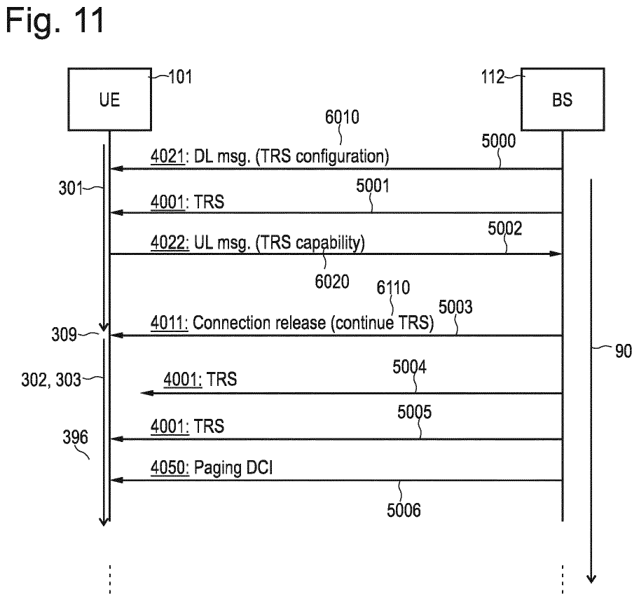

There are various options for communicating the configuration information. For instance, the configuration information could be communicated while the UE operates in the connected mode, prior to transitioning to the disconnected mode (as will be explained later in connection with FIG. 11, 5000). For instance, an RRC configuration message could include a respective information element that is indicative of the configuration information. For instance, a message that triggers the transition from the connected mode to the disconnected mode can include an information element that is indicative of the configuration information. Alternatively or additionally, it would also be possible to communicate the configuration information while the UE operates in the disconnected mode (e.g., to convey updates vis-á-vis a previously communicated configuration information). For instance, the configuration information could be included in a broadcasted system information block.

At box 3005, availability information indicative of the availability of a sporadically-on transmission of TRSs is signaled. The BS may transmit a respective message that comprises the availability information. The UE may receive a respective message. This has been explained in connection with TAB. 2, example I. Also, implicit indication would be possible, cf. TAB. 2: example II. For instance, the UE may determine the availability information based on a respective indication of a signaling mode included in the configuration information of box 3002.

Thus, while the sporadically-on transmission of TRSs may be generally configured in box 3002, it is possible that the sporadically-on transmission is switched on and switched off by the BS. Even when switched off, the UE may retain the configuration information, at least for a certain time duration; so that the BS may, again and later on, switch on the sporadically-on transmission without having to execute box 3002 again.

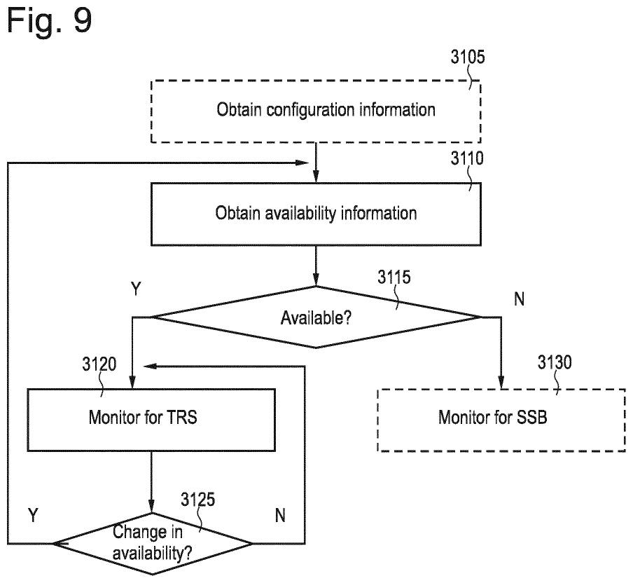

Thus, the availability information enables the UE to determine if a configured sporadi-cally-on transmission of the TRSs is available at a certain point in time, e.g., at a certain subframe or timeslot. Details with respect to such determining if a configured sporadi-cally-on transmission of the TRSs is available are explained below in connection with FIG. 9, box 3115.

Where the sporadically-on transmission of TRSs is currently switched on, this can define an on-availability; likewise, where the sporadically-on transmission of the TRSs is currently switched off, this can define an off-availability.

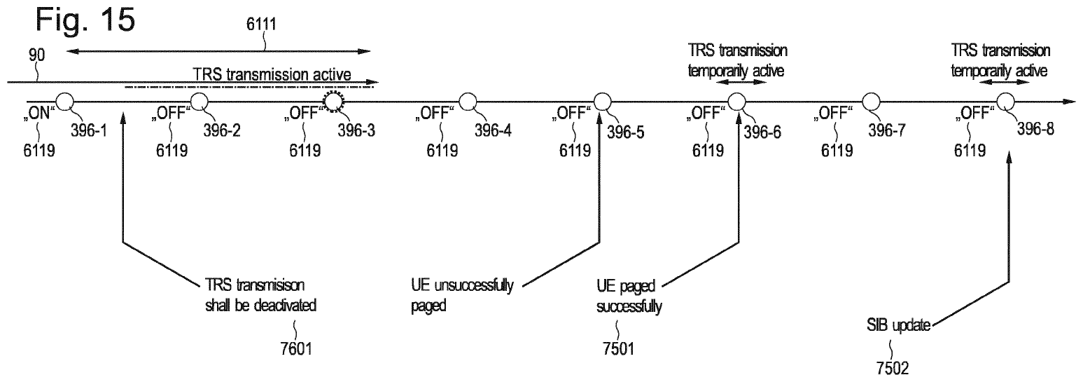

As a general rule, according to the various examples, it is possible to utilize a discrep-ancy between the actual availability of the sporadically-on transmission and the availability signaled by the availability information at box 3005. In particular, it would be possible that the availability information is indicative of an off-availability; while the spo-radically-on transmission of the TRSs is, at least for certain duration, active. Such a scenario will be later on explained in connection with FIG. 15.

At box 3010, the BS and/or the UE participate in the one or more transmissions of the TRSs in accordance with the at least one configuration of box 3005. The BS can transmit the sporadically-on RSs; and the UE can monitor for the sporadically-on RSs.

As a general rule, it is possible that multiple sporadically-on transmissions are configured at box 3002; likewise, availability information can be provided that is indicative of multiple availabilities of the multiple sporadically-on transmissions at box 3005.

According to various examples, there are multiple options available for communicating the availability information at box 3005. In particular, as explained above in connection with TAB. 1, it is possible to indicate the availability information either explicitly or implicitly.

First, examples will be described in connection with TAB. 3 that enable to explicitly indicate the availability information.

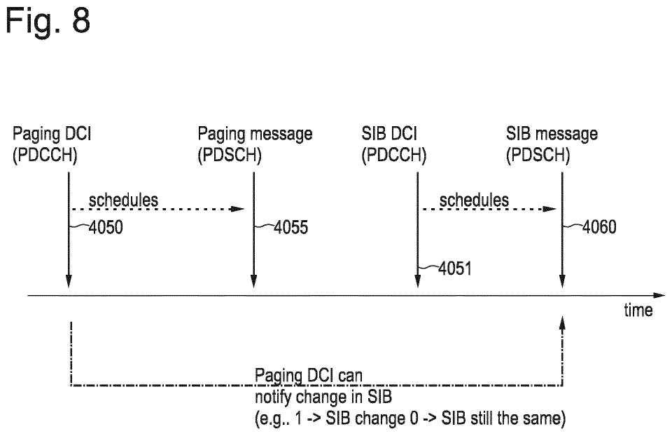

TABLE 3
Various options for explicitly signaling the availability information.
Options I, II and IV all relate to a scenario in which the DCI message
includes the availability information. For example, it would be possible
that different signaling modes are defined with respect to such options
and that it is possible to switch between the different signaling modes,
e.g., using a respective indication in configuration information.

| | Brief description | Example details |
|---|---|---|
| I | Paging DCI - | The at least one availability can be indicated by the |
| | separate | paging DCI. The paging DCI includes scheduling |
| | information | information for a paging message on the PDSCH. One or |
| | element | more bits may be added to include the availability |
| | | information. I.e., the paging DCI message can include a |
| | | respective information element that explicitly indicates |
| | | the availability information. |
| | | The paging DCI can include further information indicative |
| | | of whether the SIB has been updated (this is illustrated |
| | | by the dashed-dotted line in FIG. 8). The UE may |
| | | not be required to decode a subsequent SIB message. |
| II | SIB DCI - | The SIB DCI includes scheduling information for an SIB |
| | separate | message on the PDSCH. One or more bits may be |
| | Information | added to include the availability information. I.e., the SIB |
| | element | DCI message can include a respective information element |
| | | that explicitly indicates the availability information. |
| III | PDSCH message, | It would be possible that the SIB message - transmitted |
| | e.g., SIB | on the PDSCH - includes the availability information. |
| | | Each time the BS needs to inform there is an update in |
| | | the availability information, the UE needs to be firstly |
| | | notified that there is a SIB change. Hence, the UE needs |
| | | to decode the paging DCI followed by SIB DCI - that is |
| | | indicative of a change of the SIB - and then read the |
| | | intended SIB message. This is illustrated in FIG. 8. |
| | | It would be possible that the DCI including scheduling |
| | | information for the SIB is indicative of the availability |
| | | information having been changed vis-á-vis further |
| | | availability information previously communicated. Then, |
| | | the UE may only proceed to receive the SIB message in |
| | | case there has been a change. This reduces UE power |
| | | consumption. |
| | | Instead of SIB - communicated on PDSCH, see example |
| | | III - it would also be possible that the availability |
| | | information is included in another PDSCH message, e.g., |
| | | a paging message. |
| IV | DCI message - | The availability information can be indicated by a DCI |
| | scrambled with | message communicated on the PDCCH. This DCI message |
| | specific temporary | can include a CRC scrambled/masked with a predefined |
| | identifier | temporary identifier, e.g., a specific RNTI. For |
| | | example, if a TRS transmission has a first availability |
| | | (e.g., activated), the DCI message has CRC scrambled |
| | | with the legacy P-RNTI (i.e., is a conventional paging |
| | | DCI, see example I), but if the transmission has a |
| | | second availability (e.g., deactivated), the CRC is |
| | | scrambled with the predefined RNTI (e.g., a TRS-RNTI). This |
| | | TRS-RNTI can be indicated in the SIB or fixed in the |
| | | specifications. The TRS-RNTI is different from P-RNTI, |
| | | C-RNTI, and SI-RNTI. |

According to the various examples described herein, there are multiple options for implementing the availability information for the one or more TRS transmissions. Some options are summarized in TAB. 4.

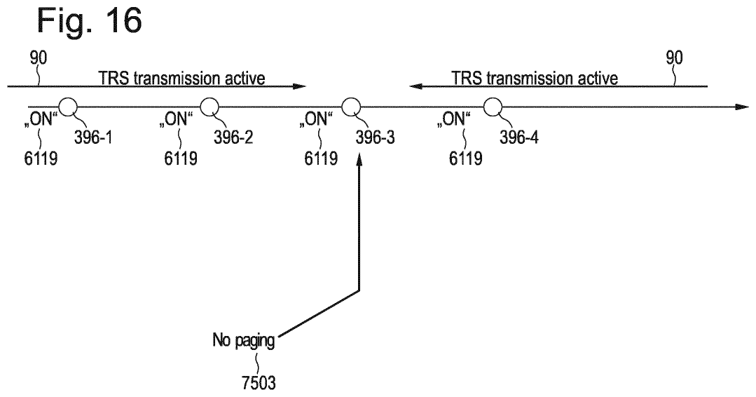

TABLE 4
Various options for information content of the availability information.
Such examples can be combined with each other or with further examples.

| | Brief description | Example details |
|---|---|---|
| I | Availability | The availability information may specify, for each one of |
| | | the one or more TRS transmissions, whether the respective |
| | | TRS transmission is currently available - i.e., |
| | | switched on - or unavailable - i.e., switched off. |
| | | I.e., the availability information may include an on- |
| | | availability (=switched on) or an off-availability |
| | | (=switched off). |
| | | Such on/off-availability 6119 is illustrated in connection |
| | | with FIG. 15 and FIG. 16. |
| II | Validity | The availability information can also include a validity. |
| | | The validity can describe how long the UE can assume |
| | | that the current availability information is applicable |
| | | without undergoing a change, e.g., toggling between on- |
| | | availability and off-availability according to example I. |
| | | During this time duration, the UE may not be required to |
| | | read the availability information again. |
| | | The validity may be expressed as a duration. The validity |
| | | may be expressed as a function of subframe number |
| | | or system frame number (SFN). |
| | | The benefit of conveying duration information is for the |
| | | BS so that the BS does not have to transmit availability |
| | | indication, particularly if there is no UE being paged at a |
| | | given duration of time. |
| | | Signaling the validity of the availability information is |
| | | also helpful for the UE. Consider a scenario in which the |
| | | availability information is indicative of an on-availability, |
| | | along with a certain validity thereof. The UE is then able |
| | | to assume that TRS will be transmitted until the end of |
| | | an associated duration or for a certain number of subframes |
| | | and hence can synchronize in a more power- |
| | | efficient manner (using TRS) than if the UE did not know |
| | | that TRS is available in accordance with the validity.. |
| | | At the end of the validity, the UE can either read the |
| | | availability information again - cf. TAB. 3 - to determine |
| | | whether the one or more TRS transmissions are available; |
| | | or revert to selecting SSB for synchronizing. If the |
| | | UE reads the availability information again, the UE can |
| | | assume the recent availability information to be valid in |
| | | accordance with the then indicated validity. |
| | | Such validity 6111 is illustrated in connection with FIG. |
| | | 15. |
| III | Multiple | Multiple availabilities - cf. example I - can be signaled |
| | availabilities | for multiple sporadically-on TRS transmissions. The BS |
| | for multiple | can support more than one TRS transmission. |
| | TRS | An example implementation is a bitmap which indicates |
| | transmissions | which TRS transmissions are currently available. For |
| | | example, if the BS has three TRS transmissions, it can |
| | | indicate a bitmap with 3 bits, e.g. “101” which indicates |
| | | that the 1st and 3rd TRS transmissions are available |
| | | (have an on-availability) whilst the 2nd TRS |
| | | transmission is not available (has an off-availability). |
| IV | Subset | The availability information could include a subset of all |
| | of POs | POs at which the availability - example I - can be |
| | | changed, e.g., from an on-availability to an off-availability. |
| | | Then, it would be possible that the UE selects |
| | | between monitoring for the TRSs and monitoring for |
| | | synchronization signal blocks, depending on whether a |
| | | respective PO is included or not included in the respective |
| | | subset. For example, the UE may interrupt an inactive |
| | | state and wake up (cf. FIG. 4) at each PO of the subset |
| | | of POs. |
| V | Trigger | According to various examples, it would be possible that |
| | events for | the availability information is indicative of one or more |
| | temporary | trigger events that trigger a temporary on-availability of |
| | override | the one or more sporadically-on transmissions of TRSs - |
| | | even though the availability information may indicate |
| | | an off-availability. I.e., the availability indicated by the |
| | | availability information and the actual availability may |
| | | diverge. |
| | | This can be helpful to provide up-to-date availability |
| | | information to the UE. |
| | | Examples of such trigger events may include a PO being |
| | | selected from a subset of a plurality of POs; also see |
| | | example IV. Another example would be paging escalation, |
| | | i.e., unsuccessful paging of the UE. Yet another |
| | | example would be a system information block update. |
| VI | Event- | The TRS transmission may be unavailable in accordance |
| | triggered | with one or more negative trigger events. These |
| | non- | one or more negative trigger events may or may not be |
| | availability | signaled to the UE; if they are signaled, they can be |
| | | included in the availability information. |
| | | For example, one or more negative trigger events could |
| | | be defined. It would be possible that the BS temporarily |
| | | suspends performing the sporadically-on TRS transmission |
| | | in response to such one or more negative trigger |
| | | events. An example would be a PO at which paging is |
| | | not executed, i.e., paging indicator and paging message |
| | | are not transmitted (as will be explained in connection |
| | | with FIG. 16 later-on). Then, TRSs may not be transmitted, |
| | | even though the sporadically-on TRS transmission |
| | | may be generally indicated as being available. |
| | | This is based on the finding that it may be acceptable if |
| | | the UE wrongly synchronizes, because it is not required |
| | | to reach the UE anyway. Thereby, resources can be |
| | | saved. |
| VII | Active | The availability information could be indicative of a |
| | configuration | currently active sporadically-on transmission selected from |
| | | multiple sporadically-on transmissions. For example, |
| | | the availability information could include an indication of |
| | | the currently active configuration and the on-availability/ |
| | | off-availability of that configuration. |
| | | As such, while example III I would indicate for multiple |
| | | sporadically-on TRS transmissions which one is on or |
| | | off, according to the example VII, it is possible to |
| | | indicate which one of multiple sporadically-on TRS |
| | | transmissions is on (or whether they are all off); the |
| | | availability of any other sporadically-on TRS transmission |
| | | is not signaled in the respective instance of the availability |
| | | information. |
| | | For example, the configuration information could configure |
| | | N_{config} different configurations of TRS, where each |
| | | configuration is associated with an index. The availability |
| | | information then signals the index and the on-availability/ |
| | | off-availability status of the sporadically-on TRS. |
| | | Specifically, the index of the currently active sporadically- |
| | | on transmission can be signaled. |
| | | This can be helpful for cases where the UE is not otherwise |
| | | aware of a change of TRS configuration, for example |
| | | if the UE did not receive a SIB that changed the TRS |
| | | configuration. The UE can then apply the appropriate |
| | | TRS configuration when synchronizing to the BS. |
| | | This can also be helpful for cases where the BS needs |
| | | to change the TRS configuration dynamically. The TRS |
| | | configuration can be changed without sending a large |
| | | RRC message defining a new TRS configuration. |
| | | In a further example, the configuration information could |
| | | configure N_{config} different configurations of TRSs, where |
| | | each configuration is associated with an index. The |
| | | availability information then signals either an index of |
| | | the sporadically-on TRS configuration that is available, |
| | | or it signals an index that indicates that sporadically-on |
| | | TRS is not available. For example, the configuration |
| | | information could configure N_{config} = 3 TRS configurations |
| | | as follows: |
| | | Index = ‘00’: TRS configuration 1 |
| | | Index = ‘01’: TRS configuration 2 |
| | | Index = ‘10’: TRS configuration 3 |
| | | The configuration information could also configure that |
| | | Index = ‘11’ relates to sporadically-on TRS being |
| | | unavailable. In this example, if the availability information |
| | | signaled Index = ‘00’, the UE would understand that |
| | | TRS configuration 1 was available; if the availability |
| | | information signaled Index = ‘11’, the UE would |
| | | understand that no TRS configuration was available. |
| | | Thus, as a general rule, it would be possible that the |
| | | availability information includes an index that is selected |
| | | from a plurality of predefined indices of a respective |
| | | codebook. This index can then specify a currently active |
| | | or inactive sporadically-on transmission selected from |
| | | multiple sporadically-on transmissions. |
| | | More generally speaking, a codebook can be used to |
| | | specify the meaning of an indicator, e.g., an n-bit index, |
| | | n being equal or larger than 1. The codebook may be |
| | | fixed in accordance with a communications protocol |
| | | used by the UE and the BS to communicate with each |
| | | other; or could be dynamically defined, e.g., in the |
| | | configuration information, cf. FIG. 7: box 3002. |
| VIII | Change | The availability information could include a change indicator |
| | indicator | indicative of a change of the configuration of the |
| | | currently available TRS transmission. For example, the |
| | | change indicator could be implemented by a counter of |
| | | the TRS configuration that is available. i.e., when the BS |
| | | changes the TRS configuration that is applied, a counter |
| | | in the availability information is updated. The UE would |
| | | compare the counter that is sent in the availability |
| | | information with a locally stored version of the counter. If |
| | | the counter values are the same, the UE would receive the |
| | | sporadically-on TRS using the locally stored configuration. |
| | | If the counter values disagree, the UE would receive |
| | | further signaling to determine the new TRS configuration |
| | | (e.g., the UE would read SIB to determine the |
| | | new TRS configuration). In its simplest form, the counter |
| | | is a 1-bit wrap-around counter. If 1-bit counter value that |
| | | it transmitted in the availability information is the same |
| | | as the locally stored 1-bit counter value, the UE can use |
| | | the locally stored configuration information, otherwise |
| | | the UE would receive further signaling to determine the |
| | | new TRS configuration. |
| | | This can be helpful for cases where the UE is not |
| | | otherwise aware of a change of TRS configuration, for |
| | | example if the UE did not receive a SIB that changed the |
| | | TRS configuration. The UE can read the new TRS |
| | | configuration if the availability information counter |
| | | indicates that the UE does not have up to date TRS |
| | | configuration information. |

Various techniques are based on the finding that care should be taken to keep knowledge of the current availability up-to-date at the UE. In particular, when TRS availability is signaled as “on”, the signaling does not have to be reliable since UEs that do not receive this availability signaling will synchronize using SSB in any case, according to existing implementations. On the other hand, when TRS availability toggles from “on” to “off”, the signaling needs to be more reliable: if a UE was to falsely assume that a TRS transmission is active, the UE may wrongly synchronize and thus may become un-reachable.

There are various options available to facilitate the UE having up-to-date knowledge regarding the current availability of the one or more TRS transmissions, or—more generally—the UE having up-to-date knowledge of any changes to the availability information of the one or more TRS transmissions. Some options are summarized in TAB. 5 below.

TABLE 5
Various options for ensuring that the UE can have an up-to-date
availability information for one or more TRS transmissions.

| | Brief description | Example details |
|---|---|---|
| I | Delayed | When TRS availability is signaled as “off”, TRS are only |
| | deactivation | actually turned off after N_TRS POs have elapsed in |
| | | which TRS are sent. |
| | | More generally, in response to changing the availability |
| | | of a sporadically-on TRS transmission from on to off, the |
| | | BS may temporarily continue to perform the sporadically- |
| | | on transmissions, i.e., temporarily continue to |
| | | transmit TRSs. An example implementation is illustrated |
| | | in TAB. 6 below. |
| | | Such temporary continuation can be in accordance with |
| | | the validity, cf. TAB. 4, example II, i.e., to meet the |
| | | validity constraints previously signaled. |
| II | Predefined | A subset of POs of all POs can be predefined to transmit |
| | toggling | the TRSs. The subset could be indicated in the availability |
| | points | information - cf. TAB. 4, example IV- or could be |
| | | predefined. The BS can execute a change in the |
| | | availability from on to off at these POs. |
| | | More specifically, the BS can stop performing a sporadically- |
| | | on transmission after a respective PO of the subset |
| | | of POs. At that PO, the availability information can |
| | | already indicate the off availability. |
| | | The UE can have knowledge of the subset of POs. |
| | | Since the UE knows when the BS could execute the |
| | | change of the availability of the one or more TRS |
| | | transmissions, the UE may only read the availability |
| | | information at the subset of POs. |
| | Fallback to | If a UE fails to be paged, when it is re-paged, the BS can |
| | activated TRS | at least temporarily (re-)activate the TRS transmission. |
| | transmission | Then, if a UE had failed to be paged as it had falsely |
| | depending on | assumed the TRS transmission was activated, it should |
| | paging success | be possible to successfully page the UE when paging is |
| | | re-tried since then the TRS transmission is again |
| | | activated so that the UE can successfully synchronize. |
| | | More specifically, the BS may transmit a paging message |
| | | to the UE when the sporadically-on TRS transmission |
| | | is not being performed. In response to determining |
| | | that the paging message did not reach the UE, the BS |
| | | may transmit a further paging message to the UE - e.g., |
| | | in the same PO or at a subsequent PO - and while |
| | | temporarily performing the sporadically-on TRS |
| | | transmission. |
| | | Still, it would be possible that the availability information |
| | | indicates an off-availability, i.e., such temporarily |
| | | performing of the sporadically-on TRS transmission in case |
| | | of a failed paging attempt may override the off- |
| | | availability indicated by the availability information. |
| IV | Fallback to | If a paging DCI or SIB DCI is transmitted to indicate an |
| | activated | update of the SIB, then one or more TRS transmissions |
| | TRS | can be temporarily activated, since some UEs might not |
| | transmission | be aware that TRS had otherwise been turned off. |
| | for SIB | Thus, it would be possible that the BS stops the performing |
| | update | of the sporadically-on transmission of TRSs, upon |
| | | indicating such change in the availability information, |
| | | i.e., the availability includes an on-availability and |
| | | is then changed to include an off-availability. Then, |
| | | after stopping the performing of the sporadically-on TRS |
| | | transmission, the BS may temporarily commence performing |
| | | of the sporadically-on TRS transmission at a PO at |
| | | which the cellular NW announces a change of the |
| | | system information block. Thus, the BS may temporarily |
| | | override the availability indicated by the availability |
| | | information. |
| V | Fallback to | It is possible that the BS stops performing the sporadically- |
| | activated | on transmission of TRSs and indicates the off- |
| | TRS | availability in the availability information. Then, after |
| | transmission | said stopping of the performing of the sporadically-on |
| | for SIB | transmission and in response to one or more trigger |
| | update | events - which may be predefined or network-defined, |
| | depending | and signaled to the UE - the BS may temporarily |
| | on trigger | commence performing of the one or more sporadically-on |
| | event | transmissions. |
| | | Examples of such trigger events have been discussed |
| | | above in connection with example III (trigger event: |
| | | paging escalation) and example IV (trigger event: system |
| | | information block update). But other trigger events |
| | | would be possible. For example, lapse of a predefined |
| | | time duration since last receiving a signal from the UE. |
| | | The trigger event can be predefined or signaled as part |
| | | of the availability information; cf. TAB. 4, example V. |

Next, an example for the delayed de-activation of the one or more TRS transmissions—cf. TAB. 5, example I—will be explained. When availability of a TRS transmission is signaled as “off”, TRS are only actually turned off after N_TRS POs have elapsed in which the TRS availability remains de-facto on. For example, when N_TRS is 3, after a decision to turn TRS off in PO n_page, the BS would send TRS according to the following pattern of TAB. 6.

TABLE 6
An example of delayed de-activation of a TRS transmission.
This is an example implementation of TAB. 5, example I.

| PO index | Paging/TRS status | Counter status |
|---|---|---|
| n_page − 1 | | |
| n_page | Paging DCI sent. TRS sent. | Count = 1 |
| | TRS availability = off | |
| n_page + 1 | Paging DCI sent. TRS sent. | Count = 2 |
| | TRS availability = off | |
| n_page + 2 | Paging DCI not sent. TRS not | Count = 2 |
| | sent. No “TRS availability” | |
| | signaling (since paging not sent) | |
| n_page + 3 | Paging DCI sent. TRS sent. | Count = 3 = |
| | TRS availability = off | N_TRS |
| n_page + 4 | Paging DCI sent. TRS not sent. | Counting process |
| | TRS availability = off | has elapsed |

Referring again to TAB. 2: above, various examples have been described that facilitate an explicit indication of the availability information of the one or more sporadically-on TRS transmissions, according to TAB. 2: example I. Next, examples will be explained in connection with TAB. 2: example II, i.e., an implicit indication of availability information of the one or more sporadically-on TRS transmissions.

Again, various options are available and such options are summarized in TAB. 7 below.

TABLE 7
Various options for an implicit indication of the availability
information. For example, it would be possible that different
signaling modes are defined with respect to such options and
that it is possible to switch between the different signaling
modes, e.g., using a respective indication in configuration information.
Implicit indication can be useful when the BS is not heavily
loaded (i.e., paging is rarely transmitted by the BS).

| | | Example details |
|---|---|---|
| I | Pre-defined | The UE can receive at least one configuration for |
| | availability | one or more sporadically-on transmissions in a |
| | | first PO, e.g., in a SIB message; cf. FIG. 7, box |
| | | 3002. Then, for a subsequent second PO or multiple |
| | | subsequent second POs, the UE may assume |
| | | that the TRS transmission is available. I.e., |
| | | the reception of a TRS configuration may imply a |
| | | certain availability. |
| | | As a general rule, the UE may infer at least one |
| | | availability of one or more sporadically-on |
| | | transmissions upon receiving at least one |
| | | configuration of the one or more sporadically- |
| | | on transmissions of TRSs. This can be in accordance |
| | | with one or more predefined rules. For instance, |
| | | these rules could specify a respective validity, |
| | | e.g., a duration or a number of subframes or |
| | | system frame number (SFN) during which the one or |
| | | more sporadically-on transmissions can be assumed |
| | | to be available. These one or more rule sets could |
| | | be defined in the communication standard. |
| II | Linked | It would be possible that the availability is |
| | to SIB | assumed to be static as long as the SIB is not |
| | | changed. Thus, any change of the SIB may indicate |
| | | that the availability changes, e.g., from on- |
| | | availability to off-availability. |

Above, various examples have been described regarding explicitly or implicitly indicating the availability information of the one or more sporadically-on transmissions of TRSs. According to various examples, it is possible to combine such different implementations. For instance, at a first PO of a plurality of POs, the availability information may be explicitly indicated; while, at a second PO of the plurality of POs, the availability information may be implicitly indicated, or vice versa. An example is explained below.

For example, when the UE comes to a new cell then the UE receives SIB explicitly including an information element specifying the at least one configuration. Then, the UE assumes the TRS transmission is available (cf. TAB. 7, example I) until the UE receives the availability information that the TRS transmission is no longer available. This corresponds to an implicit indication based on prior knowledge based on the initial SIB including the configuration information. In case the BS decides to switch off the TRS transmission for the UE operating in the disconnected mode, the BS may transmit the paging DCI message (cf. TAB. 3, example I) that includes explicit availability information indicating that TRS transmission is no longer available. Also, another DCI message could be used, cf. TAB. 3. Alternatively, the availability can also be included in the SIB (cf. TAB. 3, example III).

As a general rule, according to various examples described herein, the availability that is determined by BS can be influenced by the paging rate of the UEs in a cell. If it is low (e.g., during the night), BS can decide to set availability=0. A mobility-control node such as the AMF can send to the BS the information related to the paging rate of a cell at a given time.

FIG. 9 is a flowchart of a method according to various examples. The method of FIG. 9 may be executed by a UE. For instance, the method of FIG. 9 may be executed by the UE 101. More specifically, it would be possible that the method of FIG. 9 is executed by the control circuitry 1012 of the UE 101. Optional boxes are labeled with dashed lines.

At optional box 3105, the UE obtains a configuration information that is indicative of at least one configuration of one or more sporadically-on TRS transmissions. Details with respect to the configuration information have been explained above in connection with box 3002 of FIG. 7. The UE may obtain the configuration information when operating in a connected mode or when operating in a disconnected mode.

At box 3110, the UE obtains availability information. For instance, the availability information could be signaled explicitly; but it would also be possible that the availability information is provided implicitly, as explained in connection with TAB. 2 above.

It would be possible that the UE first determines a respective signaling mode and then attempts to obtain the availability information in accordance with the signaling mode, at box 3110. For example, the signaling mode could be indicated by the configuration information obtained at box 3105. The signaling mode could specify whether the availability information is signaled explicitly or implicitly, e.g., as described in connection with TAB. 2 above. It would also be possible that the signaling mode could specify further details of how to explicitly or implicitly signal the availability information, e.g., as discussed above in connection with TAB. 3 and TAB. 7, respectively.

The signaling mode could also be fixed.

A codebook for encoding the availability information could be set in accordance with a predefined codebook. The predefined codebook could be signaled by the communications network, e.g., in the configuration information of box 3105. For instance, the codebook could specify how one or more bits of the availability information are to be interpreted by the UE, e.g., cf. TAB. 4, example VII and example III.

In a case in which the availability information is explicitly signaled, it would be possible that the availability information is included in a paging DCI message (cf. TAB. 3: example I), a system information block DCI message (cf. TAB. 3: example II), in a dedicated DCI message having a specific temporary identifier defined for that purpose (cf. TAB. 3: example IV), or included in the system information block communicated on the PDSCH (cf. TAB. 3: example 3).

In case the availability information is implicitly obtained, it would be possible that the UE infers at least one availability of the one or more sporadically-on transmissions in accordance with one or more predefined rules, e.g., defined relatively with respect to obtaining the configuration information at box 3105. A respective example has been explained above in connection with TAB. 7: example I.

Then, at box 3115, it can be determined—e.g., at a given PO selected from a plurality of POs associated with the UE, upon transitioning from the inactive state 391 to the active state 392, cf. FIG. 4—whether the sporadically-on TRS transmission is available. This check is based on the availability information of box 3110.

Depending on such check, i.e., depending on the at least one availability, the UE can then select between monitoring for the TRS at box 3120 and monitoring for an always-on transmission of the SSB including PSS and SSS, at box 3130. This selection can be for a subsequent PO, after obtaining the availability information at box 3110.

While in the illustrated example the selection is mutually exclusive, in some examples, the UE may always monitor for the PSS and SSS, and only optionally monitor for the TRSs depending on the availability. Then both PSS/SSS and TRS may be cumulatively received, which enables a more accurate synchronization.

The selection can, in particular, take into account a validity of the availability information, i.e., whether or not the validity has expired. Options for such implementation of the validity have been explained in connection with TAB. 4: example II.

It would also be possible that such selection depends on whether a trigger event of one or more network-defined—i.e., signaled by the network—or predefined—e.g., in accordance with the communications standard—trigger events for a temporary on-availability of the one or more sporadically-on TRS transmissions are detected.

Such trigger events have been discussed in connection with TAB. 4: example V. Specifically, it would be possible to check whether the current PO is included in a subset of all POs associated with the UE. This has been discussed in connection with TAB. 4: example IV.

It would also be possible that negative trigger events are considered when selecting between monitoring for the TRSs and monitoring for the SSB: an example of negative trigger events has been discussed in connection with TAB. 4: example VI. A further example will be described in connection with FIG. 16.

At box 3120, the UE can then monitor for the TRSs. This can be in accordance with the configuration information obtained at box 3105, e.g., at respective time-frequency resources and using a respective timing.

It can then be determined at box 3125 whether there is a change in availability. In particular, the availability information could be indicative of a validity of the at least one availability of the one or more sporadically-on transmissions of TRSs, as discussed in connection with TAB. 4: example II. Then, based on this validity, it can be judged whether the previously received availability information is still up to date; in such a case, the UE can continue at a subsequent PO to monitor for the TRSs, at a further iteration of box 3120. Otherwise, in case the availability information has expired, the UE may obtain new availability information at box 3110, e.g., using one of the options described in TAB. 3 above.

In case the UE determines, at box 3115, that the one or more sporadically-on TRS transmissions are currently unavailable, the UE can proceed to box 3130 and monitor for synchronization signals included in the SSB, e.g., SSS and/or PSS.

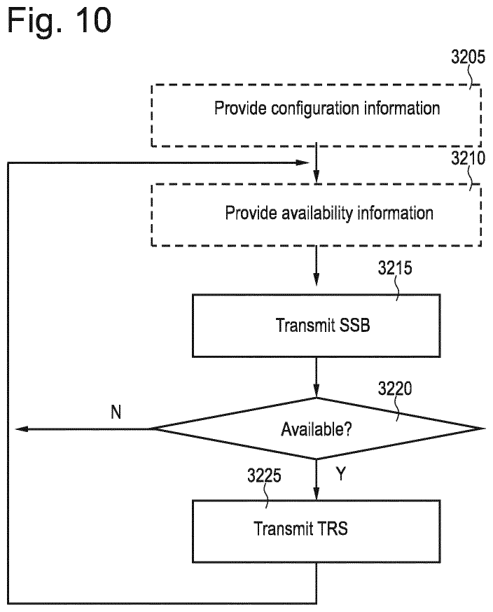

FIG. 10 is a flowchart of a method according to various examples. The method of FIG. 10 can be executed by a BS. For example, the method of FIG. 10 can be executed by the BS 112. More specifically, the method of FIG. 10 could be executed by the control circuitry 1122, upon loading program code from the memory 1123 (cf. FIG. 5).

At box 3205, the BS provides configuration information including at least one configuration of one or more sporadically-on TRS transmissions. Box 3205 is thus inter-related with box 3105 and respective considerations also apply.

The configuration information could include an activated signaling mode currently used by the BS to provide availability information at box 3210. For example, the BS may determine the activated signaling mode, e.g., based on a current cell load level or other decision criteria. The BS may switch between different signaling modes from time to time, e.g., even while a current TRS transmission is configured.

At box 3210, the BS provides availability information. This can be done in an implicit manner or explicitly, by control signaling, as already explained in connection with box 3110 of the method of FIG. 9.

In particular, the BS can transmit to the UE operating in the disconnected mode a DCI message on a control channel, e.g., PDCCH. The DCI message can include availability information indicative of at least one availability of the one or more sporadically-on transmissions of TRSs. It would also be possible that the BS transmits—in accordance with scheduling information included in the DCI message—a further message on a downlink shared channel, e.g., PDSCH; then, the availability information can be included in the further message rather than in the DCI message. The further message could be, e.g., a SIB or a paging message.

The BS may not be required to provide the availability information where the availability information is implicitly obtained by the UE, cf. TAB. 2, example II. Box 3210 is thus optional.

At box 3215, the BS performs an always-on transmission of reference signals, here primary synchronization PSS and SSS included in an SSB.

At box 3220, the BS checks, whether for a current PO, the one or more sporadically-on TRS transmissions are to be available or unavailable. This is in accordance with the availability information that may have been provided to the UE at box 3210.

In the affirmative, the method commences with box 3225 and the BS transmits the TRSs. Otherwise, the method commences with box 3210 where, if applicable, an up-dated availability information can be provided to the UE and at a further iteration of box 3215, the BS again transmits the SSB. Details with respect to the determination of box 3220 will be explained later on in connection with FIG. 15.

FIG. 11 is a signaling diagram of communication between the UE 101 and the BS 112. FIG. 11 illustrates aspects with respect to the cellular NW, specifically the BS 112, providing a configuration 6010 of the sporadically-on TRS transmission. This signaling can be used to implement box 3002 of the method of FIG. 7, as well as box 3105 of the method of FIG. 9 or box 3205 of the method of FIG. 10.

The BS 112 transmits, at 5000, a downlink message 4021, e.g., a RRC control message on PDSCH (e.g., SIB or dedicated RRC or RRC release message), including an information element indicative of the configuration information 6010 of the sporadically-on transmission. This is while the UE 101 operates in the connected mode 301.

Then, the BS 112 starts performing the sporadically-on transmission of TRSs 4001, at 5001, in accordance with the configuration information 6010.

The UE transmits an UL control message 4022 at 5002, e.g., a RRC control message on PUSCH. This UL control message 4022 is indicative of a capability of the UE 101 to monitor for TRSs when operating in a disconnected mode such as the idle mode 302. Such capability signaling is generally optional and in other examples, it would be possible that, e.g., such capability is implicitly signaled, e.g., associated with a device category of the UE, etc. 5002 could occur before 5001.

At 5003, the BS 112 then transmits a connection release control message 4011 that includes availability information 6110 indicative of the BS 112 continuing to provide the sporadically-on transmission of TRSs 4001 when the UE 101 operates in the disconnected mode 302, 303. This is optional.

Then, the UE 101 performs the transition 309 to the disconnected mode 302, 303. Subsequently, the BS performs the sporadically-on transmission of TRSs 4001, at 5004, 5005, e.g., in connection with a PO 396 or TRS is sporadically transmitted with certain periodicity until it is switched off by the BS; the UE 101 receives a TRS 4001 at 5005. The UE can then proceed to receive, based on the TRS 4001—the UE 101 thus can maintain the synchronization with the cellular NW 100, e.g., by tuning oscillators of its RF interfaces —, e.g., a paging DCI 4050 at 5006, or perform any other task (cf. TAB. 1).

While FIG. 11 illustrates a scenario in which the configuration of the sporadically-on transmission of TRS 4010 is provided while the UE 101 operates in the connected mode 301, in other examples, it would be possible that the configuration is provided while the UE 101 operates in the disconnected mode 302, 303. For example, the configuration 6010 could be included in a SIB. Thereby, it is also possible to signal changes of the configuration 6010 while the UE operates in the disconnected mode 302, 303.

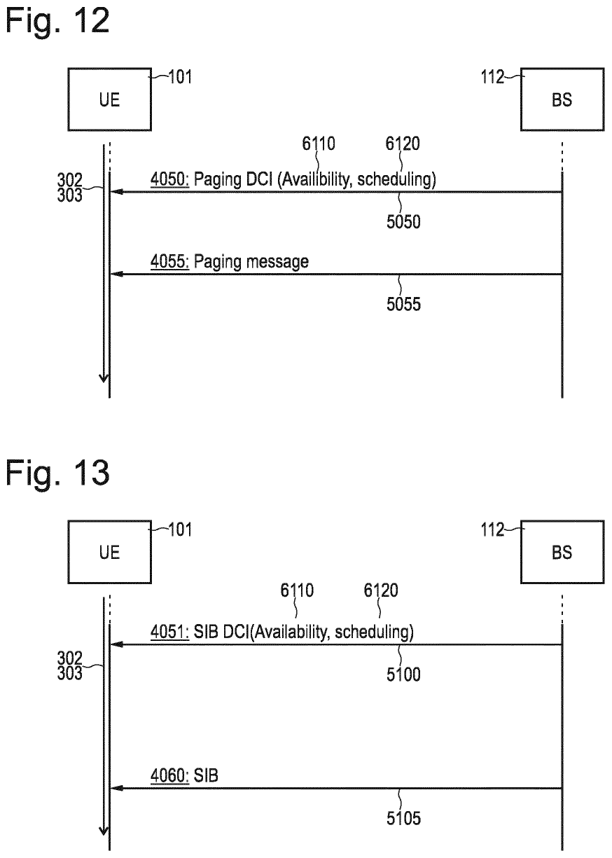

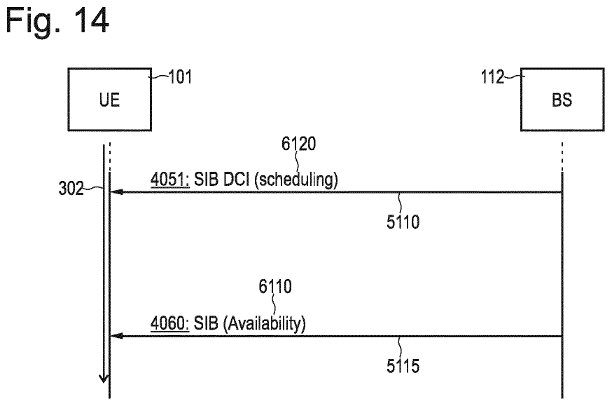

It is also possible to signal changes in the availability of the sporadically-on transmission of TRSs. Respective variants are explained in connection with FIG. 12, FIG. 13, and FIG. 14, that may follow the signaling of FIG. 11.

FIG. 12 is a signaling diagram of communication between the BS 112 and the UE 101. The signaling of FIG. 12 illustrates a variant of providing availability information 6110 from the cellular NW 100 to the UE 101. As such, the signaling of FIG. 12 can implement box 3005 of the method of FIG. 7, box 3110 of the method of FIG. 9, or box 3210 of the method of FIG. 10.

FIG. 12 illustrates a variant explained above in connection with TAB. 3: example I.

At 5050, the UE 101 receives a paging indicator 4050, i.e., a paging DCI message 4050. The paging indicator 4050 includes scheduling information 6120 for a paging message 4055 transmitted by the BS 112 at 5055. This is also illustrated in FIG. 8.

The paging indicator 4050 also includes availability information 6110 that is indicative of at least one availability of one or more sporadically-on TRS transmissions, e.g., the sporadically-on TRS transmission for which the respective configuration information 6010 has been provided by the BS 112 at 5000 (cf. FIG. 11).

FIG. 13 is a signaling diagram of communication between the BS 112 and the UE 101. The signaling of FIG. 13 illustrates a variant of providing availability information 6110 from the cellular NW to the UE 101. As such, the signaling of FIG. 13 can implement box 3005 of the method of FIG. 7, box 3110 of the method of FIG. 9, or box 3210 of the method of FIG. 10.

FIG. 13 illustrates a variant explained above in connection with TAB. 3: example II.

At 5100, a SIB DCI message 4051 is transmitted by the BS 112 and received by the UE 101. The SIB DCI message 4051 includes scheduling information 6120 for a SIB message 4060 transmitted by the BS 112 at 5105. Respective aspects have already been explained above in connection with FIG. 8 (right part).

For instance, it would be possible that the SIB message 4060 includes configuration information for one or more sporadically-on TRS transmissions.

For example, the configuration information could be indicative of a mode of providing availability information to the UE 101. Multiple modes have been discussed in connection with, e.g., TAB. 2, TAB. 3, and TAB. 7. For instance, the mode used for providing the availability information could be selected from: explicit signaling; and implicit signaling (cf. TAB. 2).

The SIB DCI message 4051 also includes the availability information 6110.

FIG. 14 is a signaling diagram of communication between the BS 112 and the UE 101. The signaling of FIG. 14 illustrates a variant of providing availability information 6110. As such, the signaling of FIG. 14 can implement box 3005 of the method of FIG. 7, box 3110 of the method of FIG. 9, or box 3210 of the method of FIG. 10.

FIG. 14 illustrates a variant explained above in connection with TAB. 3: example III.

At 5110, the BS 112 transmits a SIB DCI message 4051 which includes scheduling information 6120 for a SIB message 4060 transmitted by the BS 112 at 5115. The SIB message 4060—communicated, e.g., on the PDSCH—includes the availability information 6110. The SIB message 4060 may also include the configuration information for the sporadically-on TRS transmission.

FIG. 15 illustrates aspects with respect to operating the BS 112 in connection with a sporadically-on transmission of TRSs. FIG. 15 illustrates a sequence of POs 396-1-396-8 associated with the UE 101.

FIG. 15 illustrates techniques that facilitate reliable provision of up-to-date availability information 6110 to the UE 101— even though the UE 101 may operate in the inactive state 391 for a significant amount of time, e.g., using enhanced DRX.

The BS 112 initially performs the sporadically-on transmission 90, up and until a PO 396-3. This means that up until and during the PO 396-3 the TRS 4001 are transmitted.

However, the BS previously decides—in between the PO 396-1 and the PO 396-2—to switch off the sporadically-on transmission 90. In response to this decision made at 7601, the BS 112 changes the availability 6119 indicated by the availability information 6110 from an on-availability (signaled at the PO 396-1) to an off-availability (signaled at all subsequent POs 396-2-396-8).

As illustrated in FIG. 15, the BS—in response to changing from the on-availability to the off-availability, temporarily continues to perform the sporadically-on transmission (cf. TAB. 5, example I).

This temporary extension of the sporadically-on transmission 90—diverging from the availability 6119 indicated by the availability information 6110—could be in accordance with a validity 6111 of the availability information 6110 (cf. TAB. 4, example II). For instance, the UE 101 may read the availability information 6110 at the PO 396-1 and then enter an extended inactive state 392 (cf. FIG. 4). The UE may thus only wake up at the PO 396-3 and monitor for the TRSs 4001—which corresponds to selecting box 3120 at box 3115 of the method of FIG. 9—based on the validity 6111. To ensure that the UE 101 does not fail to synchronize (because the sporadically-on transmission 90 is already deactivated and there are no TRSs 4001 being transmitted, anymore), the sporadically-on transmission 90 is temporarily extended (illustrated by the dashed-dot-ted line).

Another reason for continuing to transmit the TRSs at the POs 396-2 and 396-3 is that the UE 101 might not have received the availability information at the POs 396-1 and 396-2. The UE might not have received the availability information for statistical reasons such as instantaneous SINR is too low, BLER is too high. By giving the UE multiple chances to read the change in availability information—i.e., here at the POs 396-1, 396-2, 396-3 —, the UE 101 is more likely to receive the availability information.

Alternatively or additionally to such stopping of the performing of the sporadically-on transmission in accordance with the validity 6111, it would also be possible that the BS 112 takes into account that the PO 396-3 is selected from a subset of all POs 396-1-396-8 (cf. TAB. 5, example II). The availability information 6110 can be indicative of the subset and the UE may decide to wake-up from its inactive state 391 at the PO 396-3 of the subset. This is because the UE 101 may be aware that the BS 112 can toggle between providing the sporadically-on transmission and not providing/stopping the sporadically-on transmission at the POs of the subset. Thus, the selection to monitor for the TRSs at the PO 396-3 depends on whether or not the respective PO 396-3 is included or not included in the subset.

Subsequently, the sporadically-on transmission is generally deactivated and the availability 6119 of the availability information 6110 also indicates that the sporadically-on transmission is unavailable. However, in response to one or more trigger events, the sporadically-on transmission can be temporarily performed (Cf. TAB. 5, example V).

This is, e.g., illustrated in connection with the POs 396-5 and 396-6. A paging message is unsuccessfully transmitted by the BS 112 at the PO 396-5, and accordingly, at the PO 396-6 the BS 112 transmits a further paging message—at 7501—while temporarily performing the sporadically-on transmission. Similarly, at PO 396-8, the BS 112 temporarily commences the sporadically-on transmission, because an update of the SIB is signaled at 7502. These are only two examples of trigger events; other trigger events are possible.

In particular, the illustrated example corresponds to positive trigger events, i.e., trigger events at which the sporadically-on transmission temporarily commences. Also negative trigger events would be conceivable; here, the sporadically-on transmission is temporarily suppressed. Such an example is discussed in connection with FIG. 16.

FIG. 16 illustrates aspects with respect to operating the BS 112 in connection with a sporadically-on transmission of TRSs. FIG. 16 illustrates a sequence of PO 396-1-396-4. The availability information 6110 indicates, for all POs 396-1-396-4, that the sporadically-on transmission is active (on-availability 6119).

Nonetheless, the BS 112—at the PO 396-3—temporarily suspends said performing of the sporadically-on transmission, because paging is not executed at 7503. This means, that at and during the PO 396-3, TRSs need not to be transmitted by the BS. This corresponds to a negative trigger event, as explained in connection with TAB. 4: example VI. It is possible, but not mandatory, that the availability information 6110 is indicative of one or more such negative trigger events that trigger a temporary off-availability of the sporadically-on transmission of the TRSs. Cf. TAB. 4, example VI.

Summarizing, at least the following EXAMPLES have been described above.

EXAMPLE 1. A method of operating a wireless communication device (101) connectable to a communications network (100), the method comprising:
when operating in a disconnected mode (302, 303): receiving, from the communications network (100), a downlink control information message (4050, 4051) on a downlink control channel, the downlink control information message (4050, 4051) comprising availability information (6110) indicative of at least one availability (6119) of one or more sporadically-on transmissions (90) of tracking reference signals (901, 902, 4001), and
when operating in the disconnected mode (302, 303): monitoring for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 2. The method of EXAMPLE 1,
wherein the downlink control information message (4050, 4051) comprises scheduling information (6120) for a further communication (4055, 4060),
wherein the further communication comprises a paging message (4055) or a system information block message (4060) transmitted by the communications network (100) on a downlink shared channel.

EXAMPLE 3. The method of EXAMPLE 1 or 2,
wherein the downlink control information message (4050, 4051) comprises an information element explicitly indicative of the at least one availability (6119).

EXAMPLE 4. The method of EXAMPLE 1 or 2,
wherein the downlink control information message (4050, 4051) comprises a checksum that is scrambled using one of multiple predefined temporary identifiers,
wherein a selection of the one of the multiple predefined temporary identifiers is indicative of the at least one availability (6119).

EXAMPLE 5. A method of operating a wireless communication device (101) connectable to a communications network (100), the method comprising:
when operating in a disconnected mode (302, 303): receiving, from the communications network (100), a downlink control information message (4050, 4051) on a downlink control channel, the downlink control information message (4050, 4051) comprising scheduling information (6120) for a further message (4055, 4060),
when operating in the disconnected mode (302, 303): receiving, in accordance with the scheduling information (6120) and from the communications network (100), the further message (4055, 4060) on a downlink shared channel, the further message (4055, 4060) comprising availability information (6110) indicative of at least one availability (6119) of at least one sporadically-on transmission of tracking reference signals, and
when operating in the disconnected mode (302, 303): monitoring for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 6. The method of EXAMPLE 5,
wherein the downlink control information message (4050, 4051) is indicative of the availability information (6110) having been changed by the communications net-work (100) with respect to a further availability information (6110) previously provided by the communications network (100).

EXAMPLE 7. The method of EXAMPLE 5 or 6,
wherein the further message (4055, 4060) is a system information block.

EXAMPLE 8. The method of any one of the preceding EXAMPLEs,
wherein the availability information (6110) is obtained by the wireless communication device (101) in a first paging occasion (396, 396-1-396-8) of a plurality of paging occasions (396, 396-1-396-8),
wherein said monitoring for the tracking reference signal is in a second paging occasion (396, 396-1-396-8) of the plurality of paging occasions (396, 396-1-396-8) different from the first paging occasion.

EXAMPLE 9. The method of any one of the preceding EXAMPLEs, further comprising:
selecting between said monitoring for the tracking reference signals (901, 902, 4001) and monitoring for further reference signals of an always-on transmission of the further reference signals, depending on the at least one availability (6119).

EXAMPLE 10. The method of EXAMPLE 9,
wherein said selecting is further depending on a predefined or network-defined validity (6111) of the availability information (6110).

EXAMPLE 11. The method of EXAMPLE 9 or 10.
wherein said selecting is further depending on one or more predefined or network-defined trigger events for a temporary on-availability of the one or more sporadically-on transmissions (90).

EXAMPLE 12. The method of any one of EXAMPLEs 9 to 11,
wherein said monitoring for the tracking reference signals (901, 902, 4001) is at or before a paging occasion (396, 396-1-396-3) of a plurality of paging occasions (396, 396-1-396-8),
wherein said selecting is further depending on whether the paging occasion is included or not included in a predefined subset of the plurality of paging occasions (396, 396-1-396-8).

EXAMPLE 13. The method of any one of EXAMPLEs 9 to 11,
wherein said selecting is further depending on one or more predefined or net-work-defined negative trigger events for a temporary off-availability of the one or more sporadically-on transmissions (90).

EXAMPLE 14. A method of operating an access node (112) of a communications network (100), the method comprising:
transmitting, to a wireless communication device (101) operating in a disconnected mode (302, 303), a downlink control information message (4050, 4051) on a control channel, the downlink control information message (4050, 4051) comprising availability information (6110) indicative of at least one availability (6119) of one or more sporadically-on transmissions (90) of tracking reference signals (901, 902, 4001), and
performing the one or more sporadically-on transmissions (90) of the tracking reference signals (901, 902, 4001) when the wireless communication device (101) operates in the disconnected mode (302, 303) and in accordance with the at least one availability (6119).

EXAMPLE 15. A method of operating an access node (112) of a communications network (100), the method comprising:
transmitting, to a wireless communication device (101) operating in a disconnected mode (302, 303), a downlink control information message (4050, 4051) on a downlink control channel, the downlink control information message (4050, 4051) comprising scheduling information (6120) for a further message (4055, 4060),
transmitting, in accordance with the scheduling information (6120) and to the wireless communication device (101) operating in the disconnected mode (302, 303), the further message (4055, 4060) on a downlink shared channel, the further message (4055, 4060) comprising availability information (6110) indicative of at least one availability (6119) of one or more sporadically-on transmissions (90) of tracking reference signals (901, 902, 4001), and
performing the one or more sporadically-on transmissions (90) of the tracking reference signals (901, 902, 4001) when the wireless communication device (101) operates in the disconnected mode (302, 303) and in accordance with the at least one availability (6119).

EXAMPLE 16. The method of EXAMPLE 14 or 15,
wherein the at least one availability (6119) comprises an on/off-availability (6119) of the one or more sporadically-on transmissions (90) of the tracking reference signals (901, 902, 4001),
wherein the method further comprises:
   in response to changing from the at least one availability (6119) comprising an on-availability to the at least one availability (6119) comprising an off-availability, temporarily continuing to perform the one or more sporadically-on transmissions (90).

EXAMPLE 17. The method of EXAMPLE 16,
wherein said temporarily continuing to perform the one or more sporadically on-transmissions is in accordance with a predefined or network-defined validity (6111) of the availability information (6110).

EXAMPLE 18. The method of any one of EXAMPLEs 14 to 17, further comprising:
wherein the at least one availability (6119) comprises an on/off-availability (6119) of the one or more sporadically-on transmissions (90) of the tracking reference signals (901, 902, 4001),
wherein the method further comprises:
   upon changing from the at least one availability (6119) comprising an on-availability to the at least one availability (6119) comprising an off-availability, stopping said performing of the one or more sporadically-on transmissions (90) after a paging occasion associated with the wireless communication device (101) selected from a subset of a plurality of paging occasions (396, 396-1-396-8).

EXAMPLE 19. The method of any one of EXAMPLEs 14 to 18,
wherein the at least one availability (6119) comprises an on/off-availability (6119) of the one or more sporadically-on transmissions (90) of the tracking reference signals (901, 902, 4001),
wherein the method further comprises:
   transmitting a paging message (4055) to the wireless communication device (101) when the at least one availability (6119) comprises an off-availability and while not performing the one or more sporadically-on transmissions (90) of the tracking reference signals (901, 902, 4001), and
   in response to determining that the paging message (4055) did not reach the wireless communication device (101): transmitting a further paging message (4055) to the wireless communication device (101) when the at least one availability (6119) comprises the off-availability and while temporarily commencing the one or more sporadically-on transmissions (90) of the tracking reference signals (901, 902, 4001).

EXAMPLE 20. The method of any one of EXAMPLEs 14 to 19,
wherein the at least one availability (6119) comprises an on/off-availability (6119) of the one or more sporadically-on transmissions (90) of the tracking reference signals (901, 902, 4001),
wherein the method comprises:
   upon changing from the at least one availability (6119) comprising an on-availability to the at least one availability (6119) comprising an off-availability, stopping said performing of the one or more sporadically-on transmissions (90),
   after said stopping of said performing of the one or more sporadically-on transmissions (90) and in response to at least one of one or more predefined or network-defined trigger events, temporarily commencing said performing of the one or more sporadically-on transmissions (90).

EXAMPLE 21. The method of EXAMPLE 20,
wherein the one or more predefined or network-defined trigger events comprise a paging occasion of a plurality of paging occasions (396, 396-1-396-8) being predefined to enable the communications network (100) announcing a change in a system information block transmitted by the communications network (100).

EXAMPLE 22. The method of any one of EXAMPLEs 14 to 21,
wherein the at least one availability (6119) comprises an on/off-availability (6119) of the one or more sporadically on-transmissions of the tracking reference signals (901, 902, 4001),
wherein the method comprises:
   while the at least one availability comprises an on-availability, temporarily suspending said performing of the one or more sporadically-on transmissions (90) at a paging occasion (396-3) at which paging is not executed (7503).

EXAMPLE 23. The method according to any one of the preceding EXAMPLEs,
wherein the availability information (6110) comprises a validity (6111) of the at least one availability (6119) of the one or more sporadically-on transmissions (90) of the tracking reference signals (901, 902, 4001).

EXAMPLE 24. The method of any one of the preceding EXAMPLEs,
wherein the availability information (6110) comprises one or more of the following:
   multiple availabilities for multiple sporadically-on transmissions;
   a change indicator indicative of an update of at least one configuration of the one or more sporadically-on transmissions;
   an indication of a currently active sporadically-on transmission selected from multiple sporadically-on transmissions; and/or
   an index selected from a plurality of predefined indices of a codebook of indices, the index specifying a currently active or inactive sporadically-on transmission selected from multiple sporadically-on transmissions; and/or
   an indicator indicative of the at least one availability in accordance with a codebook that is fixed in a communications protocol or that is defined in a configuration information provided by the communications network.

EXAMPLE 25. The method of any one of the preceding EXAMPLEs,
wherein the availability information (6110) is indicative of one or more trigger events that trigger a temporary on-availability of the one or more sporadically-on transmissions (90) of the tracking reference signals (901, 902, 4001).

EXAMPLE 26. The method of EXAMPLE 25,
wherein the one or more trigger events comprise a paging occasion (396-3) of a plurality of paging occasions (396, 396-1-396-8) associated with the wireless communication device (101) being selected from a subset of the plurality of paging occasions (396, 396-1-396-8).

EXAMPLE 27. The method of EXAMPLE 25 or 26,
wherein the one or more trigger events comprise a paging escalation (7501) of a paging procedure of the wireless communication device (101).

EXAMPLE 28. The method of any one of EXAMPLEs 25 to 27,
wherein the one or more trigger events comprise a system information block update (7502).

EXAMPLE 29. The method of any one of the preceding EXAMPLEs,
wherein the availability information (6110) is indicative of a subset of paging occasions (396-3) selected from a plurality of paging occasions (396, 396-1-396-8) associated with changing the at least one availability (6119).

EXAMPLE 30. The method of any one of the preceding EXAMPLEs,
wherein the availability information (6110) is indicative of one or more negative trigger events that trigger a temporary off-availability of the one or more sporadically-on transmissions (90) of the tracking reference signals (901, 902, 4001).

EXAMPLE 31. The method of EXAMPLE 30,
wherein the one or more negative trigger events comprise a paging occasion (396-3) without paging (7503).

EXAMPLE 32. A method of operating a wireless communication device (101) connectable to a communications network (100), the method comprising:
obtaining (3002), from the communications network (100), at least one configuration (6010) of one or more sporadically-on transmissions (90) of tracking reference signals (901, 902, 4001),
in accordance with one or more predefined rules, inferring at least one availability (6119) of the one or more sporadically-on transmissions (90),
when operating in the disconnected mode (302, 303): monitoring for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 33. A method of operating an access node (112) of a communications network (100), the method comprising:
providing, to a wireless communication device (101) operating in a disconnected mode (302, 303), availability information (6110) indicative of at least one availability (6119) of one or more sporadically-on transmissions (90) of tracking reference signals (901, 902, 4001),
between at least two signaling modes used for said providing of the availability information (6110).

EXAMPLE 34. The method of EXAMPLE 33,
wherein said switching depends on a load level in a cell of the access node.

EXAMPLE 35. The method of EXAMPLE 33 or 34,
wherein the at least two signaling modes comprise an implicit signaling of the availability information and an explicit signaling of the availability information.

EXAMPLE 36. The method of any one of EXAMPLEs 33 to 35, further comprising:
providing, to the wireless communication device (101), at least one configuration (6010) of the one or more sporadically-on transmissions (90) of tracking reference signals (901, 902, 4001),
wherein the at least one configuration is indicative an activated signaling mode of the at least two signaling modes to provide the availability information.

EXAMPLE 37. A method of operating a wireless communication device (101) connectable to a communications network (100), the method comprising:
determining an activated signaling mode used to provide availability information indicative of at least one availability (6119) of one or more sporadically-on transmissions (90) of tracking reference signals (901, 902, 4001),
when operating in a disconnected mode (302, 303): obtaining, from the communications network (100), the availability information (6110) in accordance with the activated signaling mode, and
when operating in the disconnected mode (302, 303): monitoring for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 38. A wireless communication device (101) connectable to a communications network (100), the wireless communication device comprising a control circuitry configured to:
when operating in a disconnected mode (302, 303): receive, from the communications network (100), a downlink control information message (4050, 4051) on a downlink control channel, the downlink control information message (4050, 4051) comprising availability information (6110) indicative of at least one availability (6119) of one or more sporadically-on transmissions (90) of tracking reference signals (901, 902, 4001), and
when operating in the disconnected mode (302, 303): monitor for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 39. The wireless communication device of EXAMPLE 38,
wherein the control circuitry is configured to perform the method of EXAMPLE 1.

EXAMPLE 40. A wireless communication device (101) connectable to a communications network (100), the wireless communication device comprising a control circuitry configured to:
when operating in a disconnected mode (302, 303): receive, from the communications network (100), a downlink control information message (4050, 4051) on a downlink control channel, the downlink control information message (4050, 4051) comprising scheduling information (6120) for a further message (4055, 4060),
when operating in the disconnected mode (302, 303): receive, in accordance with the scheduling information (6120) and from the communications network (100), the further message (4055, 4060) on a downlink shared channel, the further message (4055, 4060) comprising availability information (6110) indicative of at least one availability (6119) of at least one sporadically-on transmission of tracking reference signals, and
when operating in the disconnected mode (302, 303): monitor for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 41. The wireless communication device, wherein the control circuitry is configured to perform the method of EXAMPLE 5.

EXAMPLE 42. An access node (112) of a communications network (100), the access node comprising a control circuitry configured to:
transmit, to a wireless communication device (101) operating in a disconnected mode (302, 303), a downlink control information message (4050, 4051) on a control channel, the downlink control information message (4050, 4051) comprising availability information (6110) indicative of at least one availability (6119) of one or more spo-radically-on transmissions (90) of tracking reference signals (901, 902, 4001), and
perform the one or more sporadically-on transmissions (90) of the tracking reference signals (901, 902, 4001) when the wireless communication device (101) operates in the disconnected mode (302, 303) and in accordance with the at least one availability (6119).

EXAMPLE 43. The access node of EXAMPLE 42, wherein the control circuitry is configured to perform the method of EXAMPLE 14.

EXAMPLE 44. An access node (112) of a communications network (100), the access node comprising a control circuitry configured to:
transmit, to a wireless communication device (101) operating in a disconnected mode (302, 303), a downlink control information message (4050, 4051) on a downlink control channel, the downlink control information message (4050, 4051) comprising scheduling information (6120) for a further message (4055, 4060),
transmit, in accordance with the scheduling information (6120) and to the wireless communication device (101) operating in the disconnected mode (302, 303), the further message (4055, 4060) on a downlink shared channel, the further message (4055, 4060) comprising availability information (6110) indicative of at least one availability (6119) of one or more sporadically-on transmissions (90) of tracking reference signals (901, 902, 4001), and
perform the one or more sporadically-on transmissions (90) of the tracking reference signals (901, 902, 4001) when the wireless communication device (101) operates in the disconnected mode (302, 303) and in accordance with the at least one availability (6119).

EXAMPLE 45. The access node of EXAMPLE 44, wherein the control circuitry is configured to perform the method of EXAMPLE 15.

EXAMPLE 46. An access node (112) of a communications network (100), the access node comprising a control circuitry configured to:
provide, to a wireless communication device (101) operating in a disconnected mode (302, 303), availability information (6110) indicative of at least one availability (6119) of one or more sporadically-on transmissions (90) of tracking reference signals (901, 902, 4001),
switch between at least two signaling modes used for said providing of the availability information (6110).

EXAMPLE 47. The access node of EXAMPLE 46, wherein the control circuitry is configured to perform the method of EXAMPLE 33.

EXAMPLE 48. A wireless communication device (101) connectable to a communications network (100), the wireless communication device comprising a control circuitry configured to:
determine an activated signaling mode used to provide availability information indicative of at least one availability (6119) of one or more sporadically-on transmissions (90) of tracking reference signals (901, 902, 4001),
when operating in a disconnected mode (302, 303): obtain, from the communications network (100), the availability information (6110) in accordance with the activated signaling mode, and
when operating in the disconnected mode (302, 303): monitor for the tracking reference signals (901, 902, 4001) sporadically transmitted by the communications network (100) in accordance with the at least one availability (6119),
wherein the tracking reference signals (901, 902, 4001) are suitable for maintaining synchronization with the communications network (100).

EXAMPLE 49. The wireless communication device of EXAMPLE 48, wherein the control circuitry is configured to perform the method of EXAMPLE 37.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various scenarios have been described according to which a UE monitors for reference signals of a sporadically-on transmission in a preparation duration prior to a PO. As a general rule, it is not required that the reference signals are exclu-sively transmitted during the preparation duration. For example, it would be possible that the reference signals are transmitted at a fixed periodicity also after the PO and before the preparation duration.

For further illustration, scenarios have been described according to which availability information is used by the UE to determine whether or not a sporadically-on transmission of reference signals is currently available or not. According to various examples, it would not be required to rely on such availability information. For instance, in connection with TAB. 5 and FIG. 15, POs 396-6, 396-8, certain scenarios have been described in which a fallback to an activated sporadically-on transmission of reference signals is possible, e.g., depending on a trigger event, when providing an SIB update or depending on whether a paging is executed or unsuccessful. In such scenarios, use of the availability information may be dispensable.

For still further illustration, various examples have been described with respect to the tracking reference signals or generally reference signals that are suitable for maintaining synchronization with the communications network. As a general rule, similar techniques as described herein may also be used in connection with reference signals that are used for other purposes than maintaining the synchronization, e.g., for measuring a channel between the UE and the communications network.

1. A method of operating a wireless communication device connectable to a communications network, the method comprising:
when operating in a disconnected mode: receiving, from the communications network, a downlink control information message on a downlink control channel, the downlink control information message comprising availability information indicative of at least one availability of one or more sporadically-on transmissions of tracking reference signals, and
when operating in the disconnected mode: monitoring for the tracking reference signals sporadically transmitted by the communications network in accordance with the at least one availability, wherein the tracking reference signals are suitable for maintaining synchronization with the communications network.

2. The method of claim 1, wherein the downlink control information message comprises scheduling information for a further communication, wherein the further communication comprises a paging message or a system information block message transmitted by the communications network on a downlink shared channel.

3. The method of claim 1, wherein the downlink control information message comprises an information element explicitly indicative of the at least one availability.

4. The method of claim 1, wherein the downlink control information message comprises a checksum that is scrambled using one of multiple predefined temporary identifiers, wherein a selection of the one of the multiple predefined temporary identifiers is indicative of the at least one availability.

5. The method according to claim 1, wherein the availability information comprises a validity of the at least one availability of the one or more sporadically-on transmissions of the tracking reference signals.

6. The method of claim 1, wherein the availability information comprises one or more of the following:
multiple availabilities for multiple sporadically-on transmissions;
a change indicator indicative of an update of at least one configuration of the one or more sporadically-on transmissions;
an indication of a currently active sporadically-on transmission selected from multiple sporadically-on transmissions; and/or
an index selected from a plurality of predefined indices of a codebook of indices, the index specifying a currently active or inactive sporadically-on transmission selected from multiple sporadically-on transmissions; and/or
an indicator indicative of the at least one availability in accordance with a codebook that is fixed in a communications protocol or that is defined in a configuration information provided by the communications network.

7. The method of claim 1, further comprising:
selecting between said monitoring for the tracking reference signals and monitoring for further reference signals of an always-on transmission of the further reference signals, depending on the at least one availability.

8. The method of claim 7, wherein said selecting is further depending on a predefined or network-defined validity of the availability information.

9. A method of operating a wireless communication device connectable to a communications network, the method comprising:
obtaining, from the communications network, at least one configuration of one or more sporadically-on transmissions of tracking reference signals
in accordance with one or more predefined rules, inferring at least one availability of the one or more sporadically-on transmissions,
when operating in the disconnected mode: monitoring for the tracking reference signals sporadically transmitted by the communications network in accordance with the at least one availability, wherein the tracking reference signals are suitable for maintaining synchronization with the communications network.

10. A method of operating a wireless communication device connectable to a communications network, the method comprising:
when operating in a disconnected mode: receiving, from the communications network, a downlink control information message on a downlink control channel, the downlink control information message comprising scheduling information for a further message,
when operating in the disconnected mode: receiving, in accordance with the scheduling information and from the communications network, the further message on a downlink shared channel, the further message comprising availability information indicative of at least one availability of at least one sporadically-on transmission of tracking reference signals, and
when operating in the disconnected mode: monitoring for the tracking reference signals sporadically transmitted by the communications network in accordance with the at least one availability, wherein the tracking reference signals are suitable for maintaining synchronization with the communications network.

11. The method of claim 10, wherein the downlink control information message is indicative of the availability information having been changed by the communications network with respect to a further availability information previously provided by the communications network.

12. The method of claim 10, wherein the further message is a system information block.

13. The method according to claim 10, wherein the availability information comprises a validity of the at least one availability of the one or more sporadically-on transmissions of the tracking reference signals.

14. The method of claim 1, wherein the availability information comprises one or more of the following:
multiple availabilities for multiple sporadically-on transmissions;
a change indicator indicative of an update of at least one configuration of the one or more sporadically-on transmissions;
an indication of a currently active sporadically-on transmission selected from multiple sporadically-on transmissions; and/or
an index selected from a plurality of predefined indices of a codebook of indices, the index specifying a currently active or inactive sporadically-on transmission selected from multiple sporadically-on transmissions; and/or
an indicator indicative of the at least one availability in accordance with a codebook that is fixed in a communications protocol or that is defined in a configuration information provided by the communications network.

15. The method of claim 1, wherein the availability information is obtained by the wireless communication device in a first paging occasion of a plurality of paging occasions, wherein said monitoring for the tracking reference signal is in a second paging occasion of the plurality of paging occasions different from the first paging occasion.

16. The method of claim 10, further comprising:
selecting between said monitoring for the tracking reference signals and monitoring for further reference signals of an always-on transmission of the further reference signals, depending on the at least one availability.

17. The method of claim 16, wherein said selecting is further depending on a predefined or network-defined validity of the availability information.

18. The method of claim 7, wherein said selecting is further depending on one or more predefined or network-defined trigger events for a temporary on-availability of the one or more sporadically-on transmissions.

19. The method of claim 7, wherein said monitoring for the tracking reference signals is at or before a paging occasion of a plurality of paging occasions, wherein said selecting is further depending on whether the paging occasion is included or not included in a predefined subset of the plurality of paging occasions.

20. The method of claim 7, wherein said selecting is further depending on one or more predefined or net work-defined negative trigger events for a temporary off-availability of the one or more sporadically-on transmissions.

21-55. (canceled)
